(19) United States
(12) Patent Application Publication
(10) Pub. No.: US 2004/0088503 A1
(43) Pub. Date: May 6, 2004

(54) Information processing method and information processor

(75) Inventors: Ryoko Miyachi, Osaka (JP); Wataru Hashiguchi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC CO., LTD.

(21) Appl. No.: 10/687,644

(22) Filed: Oct. 20, 2003

(30) Foreign Application Priority Data
Nov. 6, 2002 (JP) 2002-321911

(51) Int. Cl. G06F 12/00; G06F 12/14

(52) U.S. Cl. 711/157; 711/158

(57) ABSTRACT

An information processing method includes the steps of: obtaining, among arithmetic instructions, information on data sets referred to by memory reference, and assigning to different banks a plurality of data sets simultaneously referred to by memory reference performed in accordance with an arithmetic instruction. This allows bank assignment to be performed automatically without causing memory bank conflict.

### BACKGROUND OF THE INVENTION

The present invention relates to information processing methods and information processors.

In DSPs, for example, an instruction (e.g., an SIMD instruction) for processing multiple data sets simultaneously is often used to increase the data processing throughput. These data sets are placed in memory areas, which are called memory banks, and when an instruction is executed, necessary data sets are transferred to an arithmetic processing unit via data buses. Since data buses are connected to memory banks in one-to-one relationships, multiple data sets cannot be sent to the arithmetic processing unit from a single memory bank at a time. Therefore, multiple memory banks are provided to correspond to multiple data buses, and multiple data sets to be processed simultaneously are placed in respectively different banks, which enables access to the multiple data sets simultaneously. Conventionally, in order to exploit such hardware capabilities, users have needed to designate in detail where the data sets are to be located in the memory, so that the data sets to be referred to simultaneously are assigned to different memory banks.

Nevertheless, as the number of data sets rises with increasing scale of development, for users to perform bank assignment manually becomes a very complicated and laborious procedure.

### SUMMARY OF THE INVENTION

The present invention solves the above problem, and an object of the present invention is that so as not to allow any arithmetic operation to be performed by referring to data sets that are placed in the same memory bank (which will be hereinafter referred to as “memory bank conflict”), data sets simultaneously referred to are automatically assigned to different memory banks, so that hardware capabilities are exploited to the fullest extent, while software productivity is increased.

In accordance with an aspect of the present invention, the above-described information processing method includes the steps of obtaining, among arithmetic instructions, information on data sets referred to by memory reference, and assigning to different banks a plurality of data sets simultaneously referred to by memory reference performed in accordance with an arithmetic instruction. This enables automatic bank assignment in which no memory bank conflict occurs.

The above-described information processing method preferably further includes the step of establishing bank assignment priority, and a step in which the assignment to the banks is performed in sequence beginning with data sets that are high in the bank assignment priority. Then, the data sets of high bank assignment priority are allowed to be assigned preferentially to the banks without causing memory bank conflict.

The above-described information processing method preferably further includes a step in which the bank assignment priority is established according to a loop count that indicates the number of times the arithmetic instruction is executed repeatedly. Then, data sets that are repeatedly referred to by loop instructions are permitted to be assigned preferentially to the banks without causing memory bank conflict.

The above-described information processing method preferably further includes a step in which the bank assignment priority is established according to data-use frequency. Then, frequently used data sets are permitted to be assigned preferentially to the banks without causing memory bank conflict.

The above-described information processing method preferably further includes the step of searching for data sets referred to simultaneously with the data sets that are high in the bank assignment priority, and a step in which the data sets referred to simultaneously are also assigned preferentially to the banks. This allows all the data sets to be assigned evenly to the banks without causing memory bank conflict.

In accordance with another aspect of the present invention, an information processing method includes the steps of reading an instruction that specifies data sets to be assigned to different banks, and assigning to the different banks the data sets that are specified to be assigned to the different banks. Then, it is possible to preferentially assign the data sets specified by the user, to the different banks, irrespective of arithmetic operation.

The information processing method preferably includes the step of reading an instruction that specifies data sets to be assigned to different banks, and a step in which the data sets that are specified to be assigned to the different banks are assigned preferentially to the banks. Then, it is possible to preferentially assign the data sets specified by the user, to the different banks, irrespective of arithmetic operation.

The information processing method preferably further includes the step of establishing bank assignment priority among the data sets that are specified to be assigned to the different banks, and a step in which in the assignment of the data sets that are specified to be assigned to the different banks, data sets that are high in the bank assignment priority are preferentially assigned to the banks. Then, the data sets of high bank assignment priority are allowed to be assigned preferentially to the banks without causing memory bank conflict.

In accordance with yet another aspect of the present invention, an information processing method includes the steps of reading an instruction that specifies to which bank a data set is assigned, and assigning the data set to the specified bank. Then, the data set specified by the user is allowed to be assigned to the designated bank.

The information processing method preferably includes the step of reading an instruction that specifies to which bank a data set is assigned, and a step in which the data set is assigned preferentially to the specified bank. Then, the data set specified by the user is allowed to be assigned preferentially to the designated bank.

In accordance with yet another aspect of the present invention, in an information processor, information on a plurality of data sets simultaneously referred to by memory reference performed in accordance with an arithmetic instruction is obtained, and the data sets are assigned to different banks. This enables automatic bank assignment in which no memory bank conflict occurs.

In the information processor, the assignment to the banks is preferably performed in sequence beginning with data sets that are high in bank assignment priority. Then, the data sets of high bank assignment priority are allowed to be assigned preferentially to the banks without causing memory bank conflict.

In the information processor, a loop count that indicates the number of times the arithmetic instruction is executed repeatedly is preferably set as the bank assignment priority. Then, data sets that are repeatedly referred to by loop instructions are permitted to be assigned preferentially to the banks without causing memory bank conflict.

In the information processor, data-use frequency is preferably set as the bank assignment priority. Then, frequently used data sets are permitted to be assigned preferentially to the banks without causing memory bank conflict.

In the information processor, data sets that are used simultaneously with the highbank-assignment-priority data sets are also preferably assigned preferentially to the banks. This allows all the data sets to be assigned evenly to the banks without causing memory bank conflict.

In accordance with still another aspect of the present invention, in an information processor, data sets to be assigned to different banks are specifiable. Then, it is possible to specify data sets to be assigned to different banks, irrespective of arithmetic operation.

In the information processor, the data sets that are specified to be assigned to the different banks are preferably assigned preferentially to the banks. Then, the data sets specified by the user are assigned preferentially to the different banks.

In the information processor, bank assignment priority is preferably established among the data sets that are specified to be assigned to the different banks, and the assignment to the banks is preferably performed in sequence beginning with data sets that are high in the bank assignment priority. Then, among the data sets specified to be assigned to the different banks, the high-priority data sets are allowed to be assigned preferentially to the banks so as not to cause memory bank conflict.

In accordance with yet another aspect of the present invention, in an information processor, a bank to which a data set is assigned is specifiable. This allows the user to directly specify to which bank a given data set should be assigned.

In the information processor, the data set specified to be assigned to the bank is preferably assigned preferentially to the specified bank. Then, the data set specified by the user is allowed to be assigned preferentially to the designated bank.

According to the present invention, information on a plurality of data sets that are referred to simultaneously by a memory reference instruction is obtained, and those data sets are assigned to different banks, so that automatic bank assignment in which no memory bank conflict occurs is performed, thereby achieving an information processor having high productivity.

Further, bank control instructions and bank-specifying instructions permit bank assignment to be performed as intended by the user, which resulting in the achievement of an information processor that can flexibly respond to the user's needs.

### BRIEF DESCRIPTION OF THE DRAWINGS

FIG. 1 is a block diagram illustrating the configuration of an information processor in accordance with a first embodiment.

FIG. 2 is a block diagram illustrating the configuration of a processor that executes an executable file produced by the information processor shown in FIG. 1.

FIG. 3 is a block diagram illustrating the inner configuration of a linker shown in FIG. 1.

FIG. 4 is a view for describing how to assign to banks data sets that are referred to by memory reference instructions.

FIG. 5 is a flow chart illustrating process steps in bank control.

FIG. 6 is a flow chart illustrating process steps in bank control.

FIG. 7 is a view for describing operation for obtaining bank control information.

FIG. 8 is a flow chart illustrating operation for obtaining bank control information.

FIG. 9 is a view for describing a bank control method.

FIG. 10 is a flow chart illustrating a bank control method.

FIG. 11 is a view for describing bank assignment operation.

FIG. 12 is a flow chart illustrating bank assignment operation.

FIG. 13 is a view for describing operation for obtaining bank control information.

FIG. 14 is a flow chart illustrating operation for obtaining bank control information.

FIG. 15 is a view for describing a bank control method.

FIG. 16 is a flow chart illustrating a bank control method.

FIG. 17 is a view for describing bank assignment operation.

FIG. 18 is a flow chart illustrating bank assignment operation.

FIG. 19 is a view for describing a bank control method.

FIG. 20 is a flow chart illustrating a bank control method.

FIG. 21 is a view for describing bank assignment operation.

FIG. 22 is a flow chart illustrating bank assignment operation.

FIG. 23 is a view for describing a bank control method.

FIG. 24 is a flow chart illustrating a bank control method.

FIG. 25 is a view for describing bank assignment operation.

FIG. 26 is a flow chart illustrating bank assignment operation.

FIG. 27 is a view for describing bank assignment operation.

FIG. 28 is a flow chart illustrating process steps in bank control.

FIG. 29 is a view for describing operation for obtaining bank control instruction information.

FIG. 30 is a flow chart illustrating operation for obtaining bank control instruction information.

FIG. 31 is a view for describing a bank control method.

FIG. 32 is a flow chart illustrating a bank control method.

FIG. 33 is a view for describing bank assignment operation.

FIG. 34 is a flow chart illustrating bank assignment operation.

FIG. 35 is a view for describing operation for obtaining bank control instruction information.

FIG. 36 is a flow chart illustrating operation for obtaining bank control instruction information.

FIG. 37 is a view for describing a bank control method.

FIG. 38 is a flow chart illustrating a bank control method.

FIG. 39 is a view for describing bank assignment operation.

FIG. 40 is a flow chart illustrating bank assignment operation.

FIG. 41 is a view for describing bank assignment operation.

FIG. 42 is a flow chart illustrating process steps in bank control.

FIG. 43 is a view for describing operation for obtaining bank-specifying instruction information.

FIG. 44 is a flow chart illustrating operation for obtaining bank-specifying instruction information.

FIG. 45 is a view for describing bank assignment operation.

FIG. 46 is a flow chart illustrating bank assignment operation.

FIGS. 47A and 47B are views illustrating the structure of bank control information.

FIGS. 48A through 48D are views illustrating the structure of bank assignment group information.

FIGS. 49A and 49B are views illustrating the structure of bank control instruction information.

FIGS. 50A and 50B are views illustrating the structure of bank assignment group information for bank control instruction.

FIG. 51 is a view illustrating the structure of bank-specifying instruction information.

### DESCRIPTION OF THE PREFERRED EMBODIMENTS

Hereinafter, embodiments of the present invention will be described in detail with reference to the accompanying drawings. The same members or equivalent members shown in the drawings are identified by the same reference marks and the description thereof will not be repeated herein.

(First embodiment)

<Configuration of information processor>

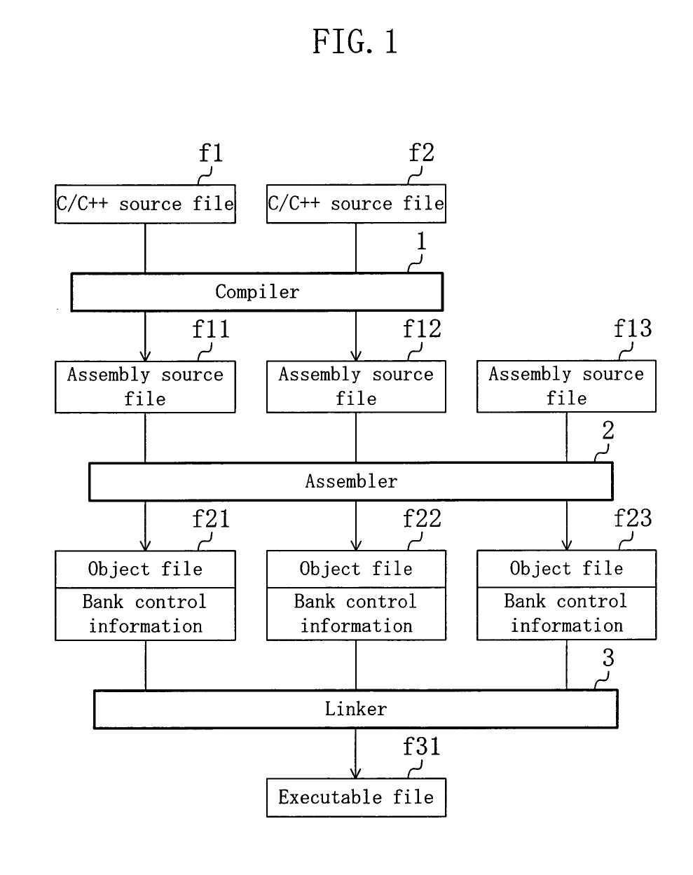

FIG. 1 illustrates the configuration of an information processor in accordance with a first embodiment. The information processor creates an executable file f31 from C/C++ source files f1 and f2 and an assembly source file fl3. The C/C++ source files f1 and f2 are input files created by a user using C/C++ language. The assembly source file f13 is an input file generated by the user using assembly language.

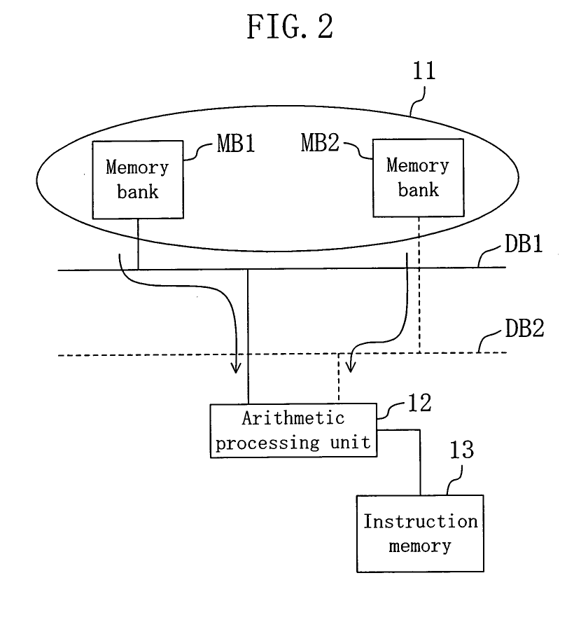

The executable file f31 produced by the information processor is executed on a processor (target computer) shown in FIG. 2. The processor shown in FIG. 2 includes a data memory 11, data buses DB1 and DB2, an arithmetic processing unit 12, and an instruction memory 13. The data memory 11 is an area where data sets which are referred to by arithmetic instructions are placed. The data memory 11 includes memory banks MB1 and MB2. The data bus DB1 is a line which connects the memory bank MB1 and the arithmetic processing unit 12, whereas the data bus DB2 is a line via which the memory bank MB2 is connected to the arithmetic processing unit 12. Data placed in the memory bank MB1 is transferred to the arithmetic processing unit 12 through the data bus DB1. However, the data bus DB1, which is not capable of transferring multiple sets of data at a time, cannot simultaneously transfer multiple data sets placed in the memory bank MB1. Thus, transfer of a given data set has to be completed before an ensuing data set can be transferred. The same is true for data placed in the memory bank MB2. The arithmetic processing unit 12 refers to data placed in the data memory 11 and actually performs arithmetic operations. The instruction memory 13 is an area in which arithmetic instructions carried out by the arithmetic processing unit 12 are stored.

Referring again to FIG. 1, the information processor includes a compiler 1, an assembler 2 and a linker 3. The compiler 1 converts the C/C++source files f1 and f2 into assembly source files f11 and f12. The assembler 2 converts the assembly source files f11 through f13 into object files f21 through f23. The assembler 2 outputs bank control information as well as the object files f21 through f23. The linker 3 combines the object files f21 through f23 to generate the executable file f31. The linker 3 also performs bank control in accordance with the bank control information.

<Inner configuration of linker 3>

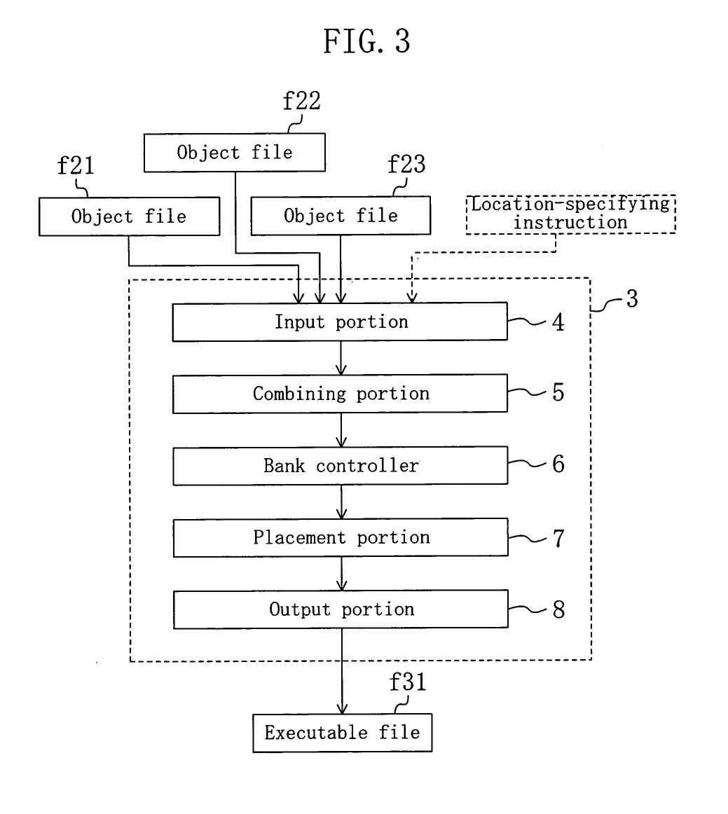

FIG. 3 illustrates the inner configuration of the linker 3 shown in FIG. 1. The linker 3 includes an input portion 4, a combining portion 5, a bank controller 6, a placement portion 7, and an output portion 8. The object files f21 through f23 are inputted into the input portion 4. Depending on the situation, a location-specifying instruction is also inputted. The location-specifying instruction, which is user-definable, specifies where data sets used in the object files f21 through f23 are to be placed when the data sets are placed in the memory. In the combining portion 5, the inputted object files f21 through f23 are combined into a single executable film. The bank controller 6 performs, according to the bank control information, bank control for the data sets used in the object files f21 through f23. The placement portion 7 places the data sets used in the object files 121 through f23, in banks designated by the bank control. The output portion 8 outputs the executable file f31 created through the operations performed by the input portion 4 through the placement portion 7.

<Data assignment to memory banks>

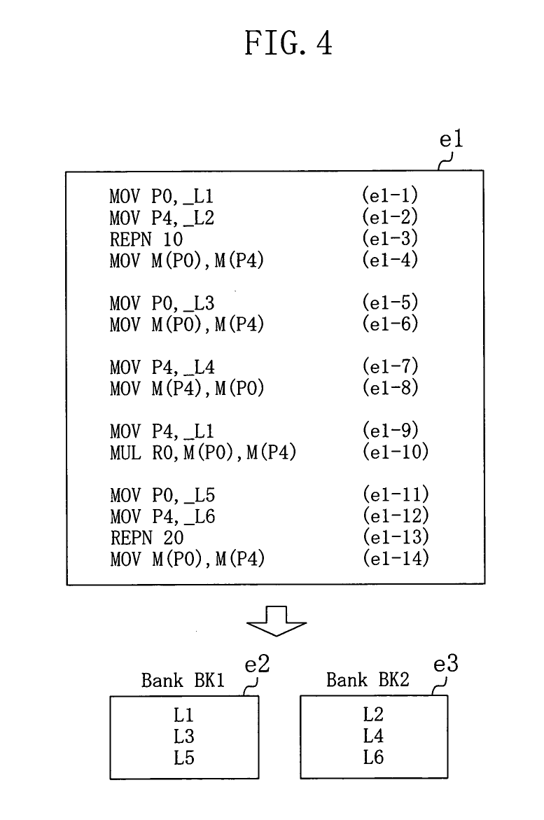

Hereinafter, referring to FIG. 4, it will be described how to perform bank control, in which data sets, referred to by memory reference instructions of the arithmetic instructions executed on the processor of FIG. 2, are assigned to banks.

The reference mark el indicates an example of an input file in which memory reference instructions are written. Now, assembler instructions e1-1 through e1-14 written in the input file e1 will be discussed.

The assembler instruction e1-1 is an instruction that the address of a memory in which data L1 is stored be assigned to a register P0. The assembler instruction e1-2 is an instruction that the address of a memory in which data L2 is stored be assigned to a register P4.

The assembler instruction e1-3 is a loop instruction designating the repetition 10 times of the assembler instruction e1-4, which is the instruction next executed after the assembler instruction e1-3.

The assembler instruction e1-4 is an instruction to perform a memory reference (which will be hereinafter referred to as a memory reference instruction). The assembler instruction e1-4 indicates that the data stored in the memory specified by the memory address that has been assigned to the register P4 is to be stored in the memory specified by the memory address that has been assigned to the register P0. The character “M” shown in the instruction e1-4 means that a memory reference will be performed. Since the data L1 stored in the memory indicated by the memory address assigned to the register P0 and the data L2 stored in the memory indicated by the memory address assigned to the register P4 are referred to simultaneously, the data L1 and the data L2 need to be assigned to different memory banks.

The assembler instruction e1-5 is an instruction that the address of a memory in which data L3 is stored be assigned to the register P0.

The assembler instruction e1-6 is a memory reference instruction, which indicates that the data stored in the memory specified by the memory address that has been assigned to the register P4 is to be stored in the memory specified by the memory address that has been assigned to the register P0. Since the data L3 stored in the memory indicated by the memory address assigned to the register P0 and the data L2 stored in the memory indicated by the memory address assigned to the register P4 are referred to simultaneously, the data L3 and the data L2 have to be assigned to different memory banks.

The assembler instruction e1-7 is an instruction that the address of a memory in which data L4 is stored be assigned to the register P4.

The assembler instruction e1-8 is a memory reference instruction, which indicates that the data stored in the memory specified by the memory address assigned to the register P0 is to be stored in the memory specified by the memory address assigned to the register P4. Since the data L3 stored in the memory indicated by the memory address assigned to the register P0 and the data L4 stored in the memory indicated by the memory address assigned to the register P4 are referred to simultaneously, the data L3 and the data L4 have to be assigned to different memory banks.

The assembler instruction e1-9 is an instruction that the address of the memory in which the data L1 is stored be assigned to the register P4.

The assembler instruction e1-10 is a memory reference instruction to assign to a register R0 the result of multiplying the data stored in the memory indicated by the memory address assigned to the register P0 by the data stored in the memory indicated by the memory address assigned to the register P4. Since the data L3 stored in the memory indicated by the memory address assigned to the register P0 and the data L1 stored in the memory indicated by the memory address assigned to the register P4 are referred to simultaneously, the data L3 and the data L1 have to be assigned to different memory banks.

The assembler instruction e1-11 is an instruction that the address of a memory in which data L5 is stored be assigned to the register P0. The assembler instruction e1-12 is an instruction that the address of a memory in which data L6 is stored be assigned to the register P4. The assembler instruction e1-13 is a loop instruction designating the repetition times of the assembler instruction e1-14, which is the instruction next executed after the assembler instruction e1-13.

The assembler instruction e1-14 is a memory reference instruction, which indicates that the data stored in the memory specified by the memory address assigned to the register P4 is to be stored in the memory specified by the memory address assigned to the register P0. Since the data L5 stored in the memory indicated by the memory address assigned to the register P0 and the data L6 stored in the memory indicated by the memory address assigned to the register P4 are referred to simultaneously, the data L5 and the data L6 have to be assigned to different memory banks.

In this manner, the data L1 through the data L6, which are referred to in the input file e1, have been assigned to the memory banks MB1 and MB2, and the results are indicated by the reference marks e2 and e3. The reference mark e2 indicates a group of the addresses of the memories in which, among the data sets referred to in the input file e1, the data sets that have been assigned to the memory bank MB1 are stored, whereas the reference mark e3 indicates a group of the addresses of the memories in which, among the data sets referred to in the input file el, the data sets that have been assigned to the memory bank MB2 are stored.

Next, it will be described how to perform bank assignments (bank control) such as shown in FIG. 4. In this embodiment, bank-assignment priority levels among all data sets are all equal in the processor shown in FIG. 2.

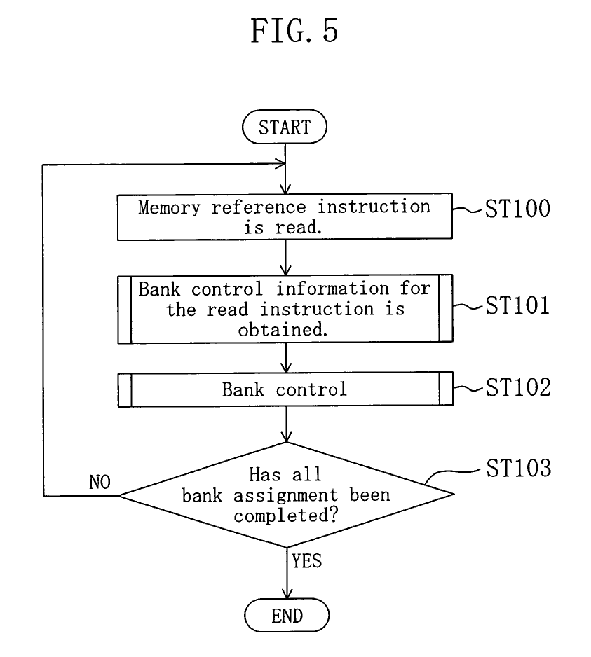

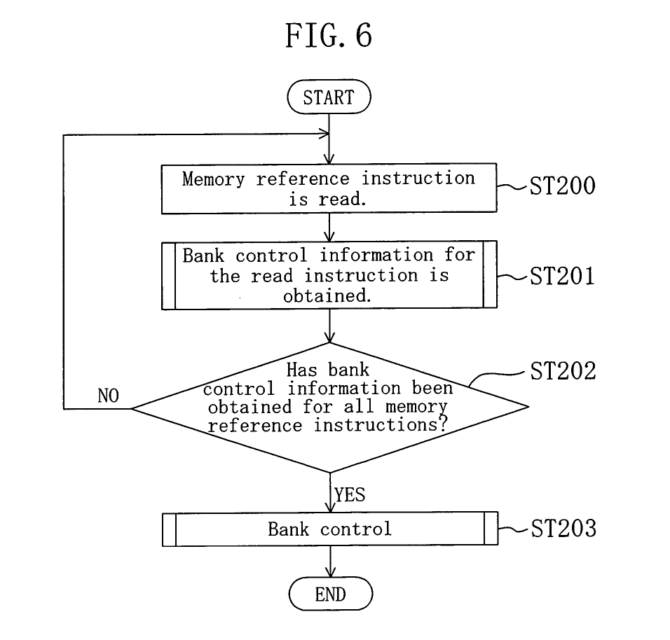

FIGS. 5 and 6 are flow charts illustrating how bank control process steps are performed. In this embodiment, either of the methods of FIGS. 5 and 6 may be used.

FIG. 5 shows a flow of process steps in bank control, in which bank assignment which causes no memory bank conflict is automatically performed, while information needed by a memory reference instruction performed by the arithmetic processing unit 12 is read.

In Step ST100, a memory reference instruction performed by the arithmetic processing unit 12 is read. In Step ST101, necessary information for the bank control is obtained for the memory reference instruction that has been read in Step ST100. In Step ST102, the bank control is performed. In Step ST103, a determination is made as to whether all bank assignment has been completed for all memory reference instructions performed by the arithmetic processing unit 12. If it has been determined in Step ST103 that all the bank assignment has been completed, the process is ended. If it has been determined in Step ST103 that all the bank assignment has not been completed, the process returns to Step ST100 to repeat the operations of Step ST100 through Step ST103.

FIG. 6 shows a flow of process steps in bank control, in which bank assignment which causes no memory bank conflict is automatically performed, after all information needed by all memory reference instructions performed by the arithmetic processing unit 12 has been read.

In Step ST200, a memory reference instruction performed by the arithmetic processing unit 12 is read. In Step ST201, necessary information for the bank control is obtained for the memory reference instruction that has been read in Step ST200. In Step ST202, a determination is made as to whether all information necessary for bank control has been obtained for all memory reference instructions performed by the arithmetic processing unit 12. In the case where it has been determined in Step ST202 that all the necessary information has been obtained, the bank control is performed in Step ST203. If it has not been determined in Step ST202 that all the necessary information has been obtained, the process returns to Step ST200 to repeat the operations of Step ST200 through Step ST202.

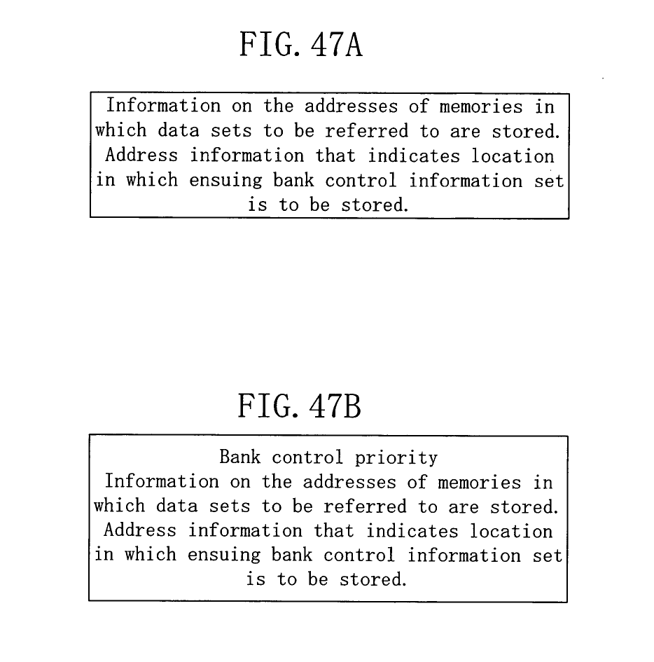

Now, referring to FIG. 47A, the above-mentioned necessary information for bank control (which will be hereinafter referred to as “bank control information”) will be described. A bank control information set shown in FIG. 47A is generated each time a memory reference instruction is read. The bank control information set includes information on the addresses of memories in which data sets to be referred to are stored, and address information that indicates a location in which an ensuing bank control information set is to be stored. By holding the address information that indicates the ensuing-bank-control-information-set storage location, all of the bank control information sets are connected in a list structure. The address information that indicates the ensuingbank-control-information-set storage location is registered at the time that the ensuing bank control information set has been created.

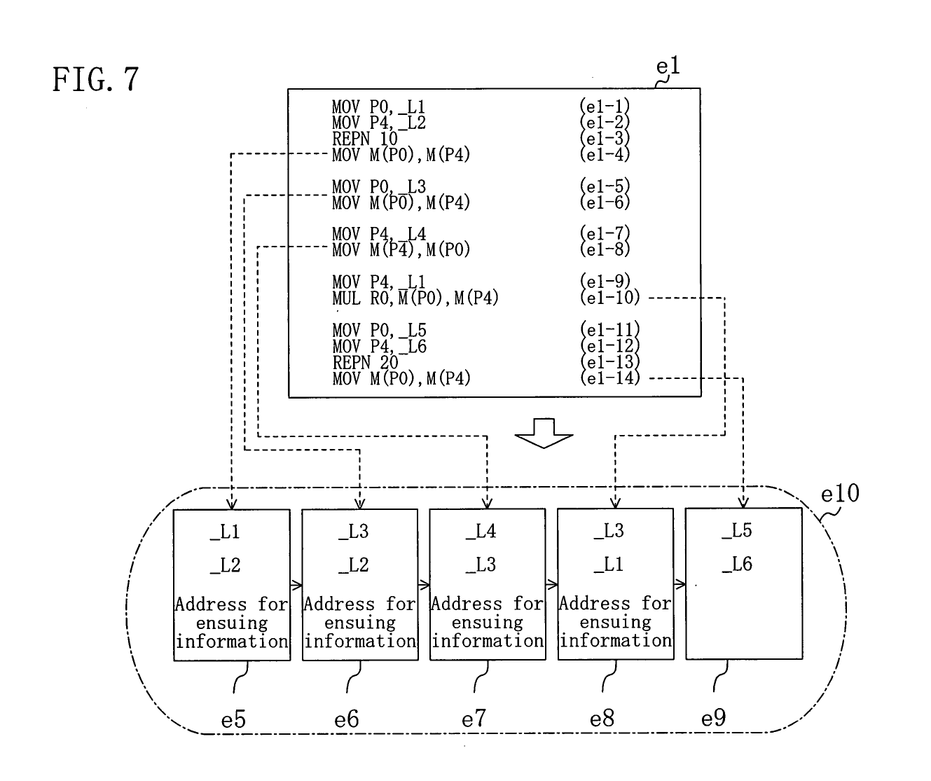

Next, operation for obtaining the bank control information set shown in FIG. 47A will be discussed with reference to FIG. 7.

The reference mark e1 indicates an example of an input program in which memory reference instructions are written. The reference mark e5 indicates a bank control information set obtained in accordance with a memory reference instruction e1-4. By the memory reference instruction e1-4, since data L1 and data L2 are referred to simultaneously, the address _L1 of a memory in which the data L1 is stored and the address _L2 of a memory in which the data L2 is stored are registered in memory address information in the bank control information set e5.

The reference mark e6 indicates a bank control information set obtained according to a memory reference instruction e1-6. By the memory reference instruction e1-6, since data L3 and the data L2 are referred to simultaneously, the address _L3 of a memory in which the data L3 is stored and the address _L2 of the memory in which the data L2 is stored are registered in memory address information in the bank control information set e6. The bank control information set e6 is connected to the bank control information set e5.

The reference mark e7 indicates a bank control information set obtained according to a memory reference instruction e1-8. By the memory reference instruction e1-8, since data L4 and the data L3 are referred to simultaneously, the address _L4 of a memory in which the data L4 is stored and the address _L3 of the memory in which the data L3 is stored are registered in memory address information in the bank control information set e7. The bank control information set e7 is connected to the bank control information set e6.

The reference mark e8 indicates a bank control information set obtained according to a memory reference instruction e1-10. By the memory reference instruction e1-10, since the data L3 and the data L1 are referred to simultaneously, the address _L3 of the memory in which the data L3 is stored and the address _L1 of the memory in which the data L1 is stored are registered in memory address information in the bank control information set e8. The bank control information set e8 is connected to the bank control information set e7.

The reference mark e9 indicates a bank control information set obtained according to a memory reference instruction e1-14. By the memory reference instruction e1-14, since data L5 and data L6 are referred to simultaneously, the address _L5 of a memory in which the data L5 is stored and the address _L6 of a memory in which the data L6 is stored are registered in memory address information in the bank control information set e9. The bank control information set e9 is connected to the bank control information set e8.

The above operations produce a bank control information list e10 which includes the bank control information sets e5 through e9.

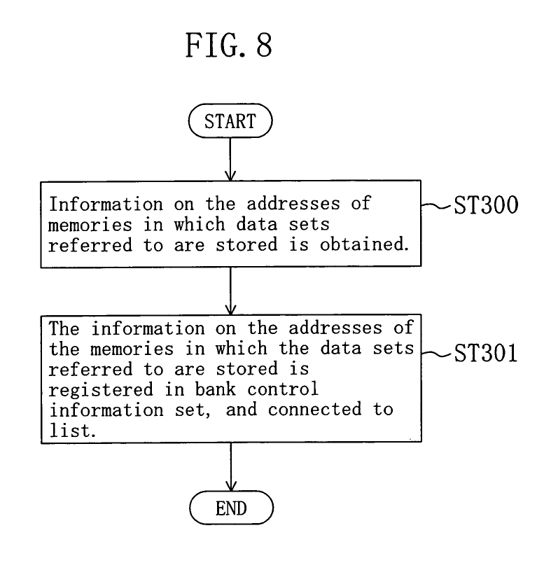

Subsequently, the operation for obtaining the bank control information sets shown in FIG. 7 will be described more specifically with reference to FIG. 8. FIG. 8 is a flow chart illustrating the operation for obtaining the bank control information set shown in FIG. 47A. The flow chart corresponds to the operation of Step ST101 in FIG. 5 and the operation of Step ST201 in FIG. 6.

Step ST300 is to obtain information on the addresses of memories in which data sets to be referred to by a memory reference operation performed by the arithmetic processing unit 12 are stored. In Step ST301, the memory address information set obtained in Step ST300 is registered in the corresponding bank control information set, and the bank control information set is connected to the bank control information list.

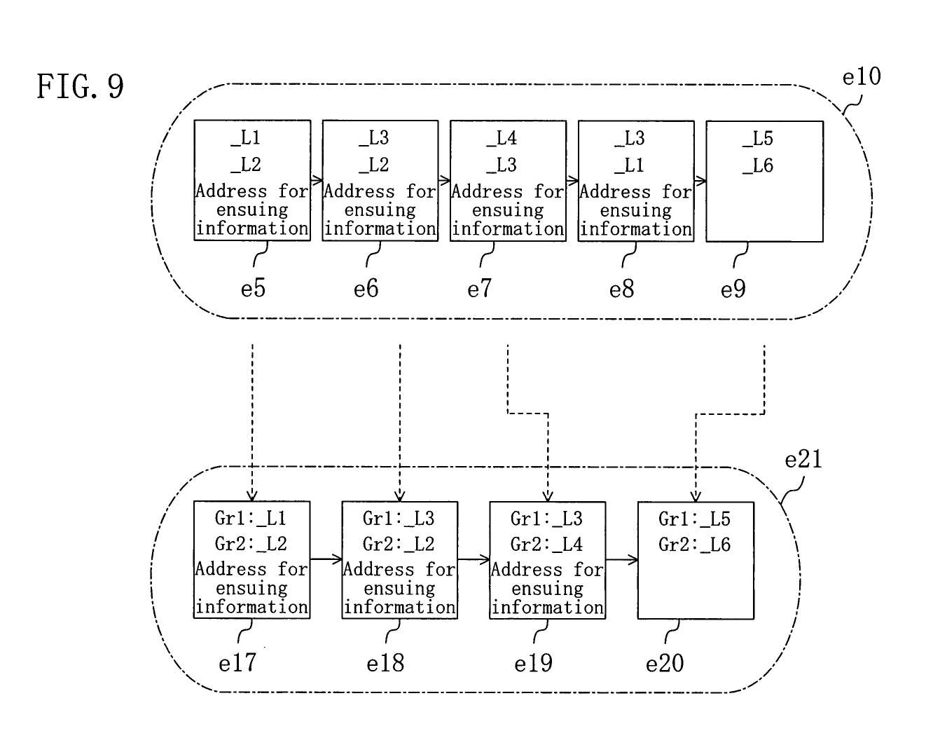

Next, a bank control method in which all bank-assignment priority levels are equal will be described with reference to FIG. 9.

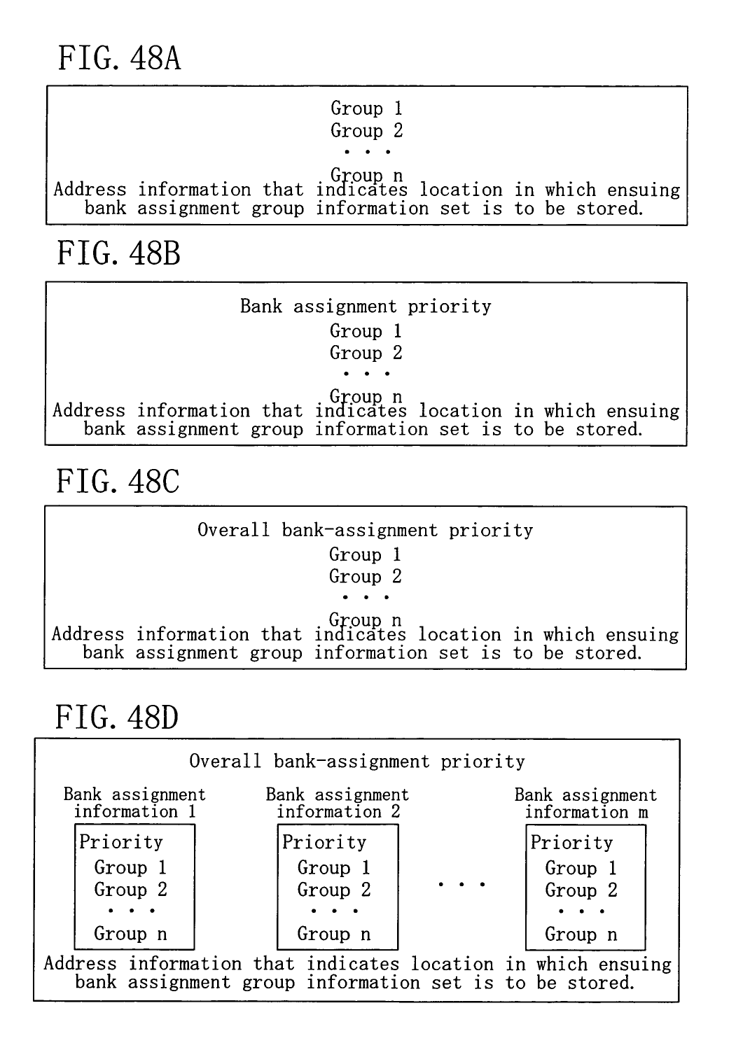

The reference mark e10 indicates a bank control information list. The reference marks e5 through e9 denote bank control information sets included in the bank control information list e10. The reference marks e17 through e20 indicate bank assignment group information sets created from the bank control information sets e5 through e9. Now, the bank assignment group information sets produced in the first embodiment will be described with reference to FIG. 48A. In the first embodiment, bank assignment group information shown in FIG. 48A is generated.

Each bank assignment group information set illustrated in FIG. 48A includes: information obtained as a result of the grouping of memory addresses performed based on the bank control information in such a manner that the addresses of memories in which data sets to be assigned to the same bank are stored are grouped into the same group, while the addresses of memories in which data sets to be assigned to different banks are stored are grouped into different groups; and address information that indicates where the ensuing bank assignment group information set is to be stored. In this embodiment, the number of groups is equal to the number of banks. By holding the address information that indicates the ensuing-bank-assignment-group-information-set storage location, all of the bank assignment group information sets are connected in a list structure. The address information indicating the ensuing-bank-assignment-group-information-set storage location, is registered at the time when the ensuing bank assignment group information set has been created.

Therefore, the bank assignment group information set e17 generated from the bank control information set e5 indicates the results of grouping memories in which data L1 and data L2 are stored, into different groups so that memory addresses _L1 and _L2 registered in memory address information in the bank control information set e5 are grouped into Gr (group)1 and Gr2, respectively.

Further, the bank assignment group information set e18 generated based on the bank control information set e6 indicates the results of grouping memory addresses _L3 and _L2 that are registered in memory address information in the bank control information set e6. In this grouping process, since the memory address _L2 has already been grouped by the bank assignment group information set e17 into the group Gr2, the memory address _L3 is grouped into Gr1, which is a different group from that of the memory address _L2. The bank assignment group information set e18 is connected to the bank assignment group information set e17.

Likewise, the bank assignment group information set e19 produced based on the bank control information set e7 indicates the results of grouping the memory addresses _L3 and _L4 into the groups Gr1 and Gr2, respectively. The bank assignment group information set e20 created based on the bank control information set e9 indicates the results of grouping memory addresses _L5 and _L6 into the groups Gr1 and Gr2, respectively.

The memory addresses _L1 and _L3 are registered in memory address information in the bank control information set e8. However, at the time that the bank control information set e8 is read, the memory addresses _L1 and _L3 have both already been registered in the bank assignment group information sets, thus eliminating the need for creating a new bank assignment group information set.

The above operations produce a bank assignment group information list e21 which includes the bank assignment group information sets e17 through e20. The banks are assigned in sequence beginning with the data sets indicated by the memory addresses registered in the bank assignment group information set e17 at the head of the bank assignment group information list e21.

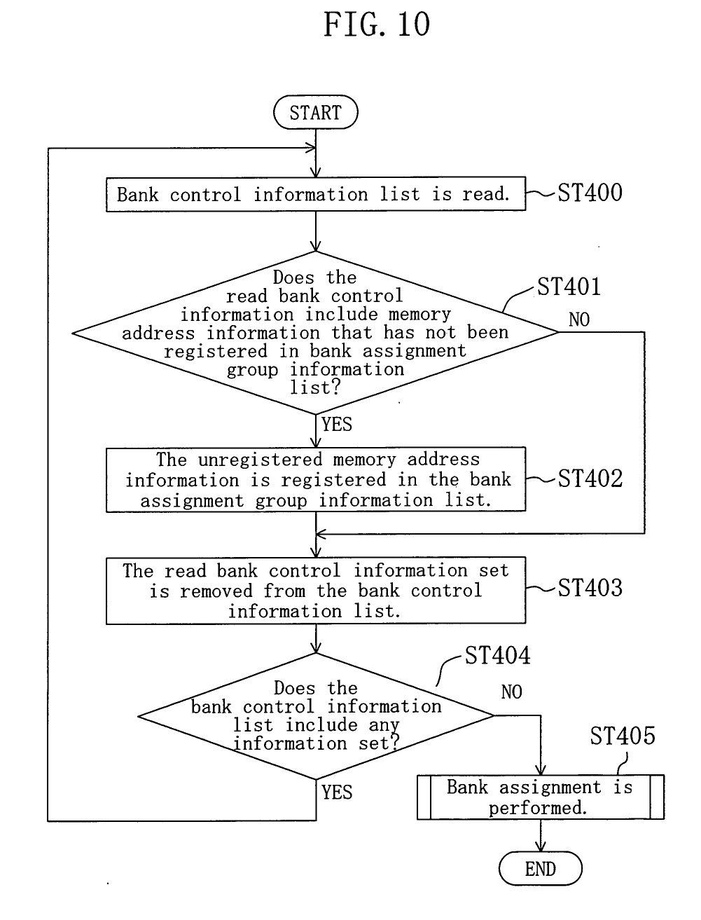

Next, the bank control method shown in FIG. 9 will be described more specifically with reference to FIG. 10.

FIG. 10 is a flow chart illustrating the bank control method in which bank-assignment priority levels are equal among all of the data sets. The flow chart corresponds to the operation of Step ST102 in FIG. 5 and the operation of Step ST203 in FIG. 6.

In Step ST400, the head of the bank control information list is read.

In Step ST401, a determination is made as to whether the memory addresses indicated by memory address information within the read bank control information set include any memory address which has not yet been registered in the bank assignment group information list.

If it has been determined in Step ST401 that there is a memory address that has not yet been registered in the bank assignment group information list, then in Step ST402 the unregistered memory address is registered in the bank assignment group information list as a group that is different from a group in which the other memory address that the memory address information within the same bank control information set indicates has already been registered.

In Step ST403, the read bank control information set is removed from the bank control information list.

In Step ST404, it is determined whether the bank control information list includes any bank control information set that has not been processed. If it has been determined in Step ST404 that the bank control information list still includes a bank control information set that has not yet been processed, the process returns to Step ST400 to repeat the operations of Steps ST400 through ST404. If it has been determined in Step ST404 that there is no bank control information set that has not been processed in the bank control information list, then bank assignment is performed in Step ST405.

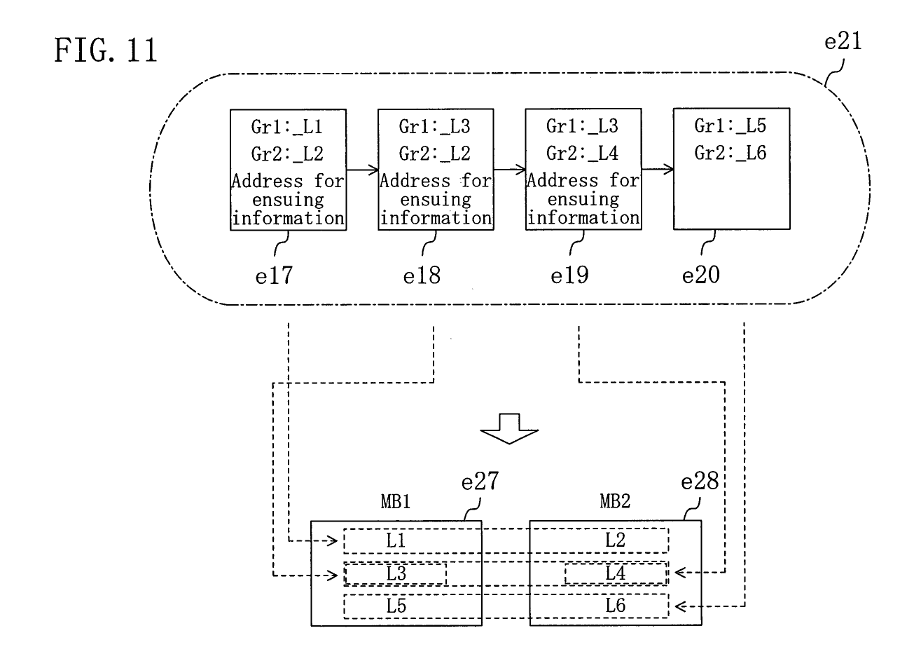

Next, bank assignment operation which corresponds to the operation of Step ST405 in FIG. 10 will be discussed with reference to FIG. 11. FIG. 11 illustrates an exemplary bank assignment operation in which all bank-assignment priority levels among all data sets are equal.

The reference mark e21 denotes a bank assignment group information list. The reference marks e17 through e20 indicate bank assignment group information sets included in the bank assignment group information list e21.

The reference marks e27 and e28 indicate memory banks in which data sets are stored, and show the result of assigning the data sets to the banks in sequence beginning with the data sets stored in the areas indicated by the memory addresses registered in the bank assignment group information set e17 at the head of the bank assignment group information list e21. In FIG. 11, data L1, data L3 and data L5 are assigned to the memory bank MB1, while data L2, data L4 and data L6 are assigned to the memory bank MB2. Alternatively, the data L2, data L4 and data L6 may be assigned to the memory bank MB1, whereas the data L, data L3 and data L5 may be assigned to the memory bank MB2.

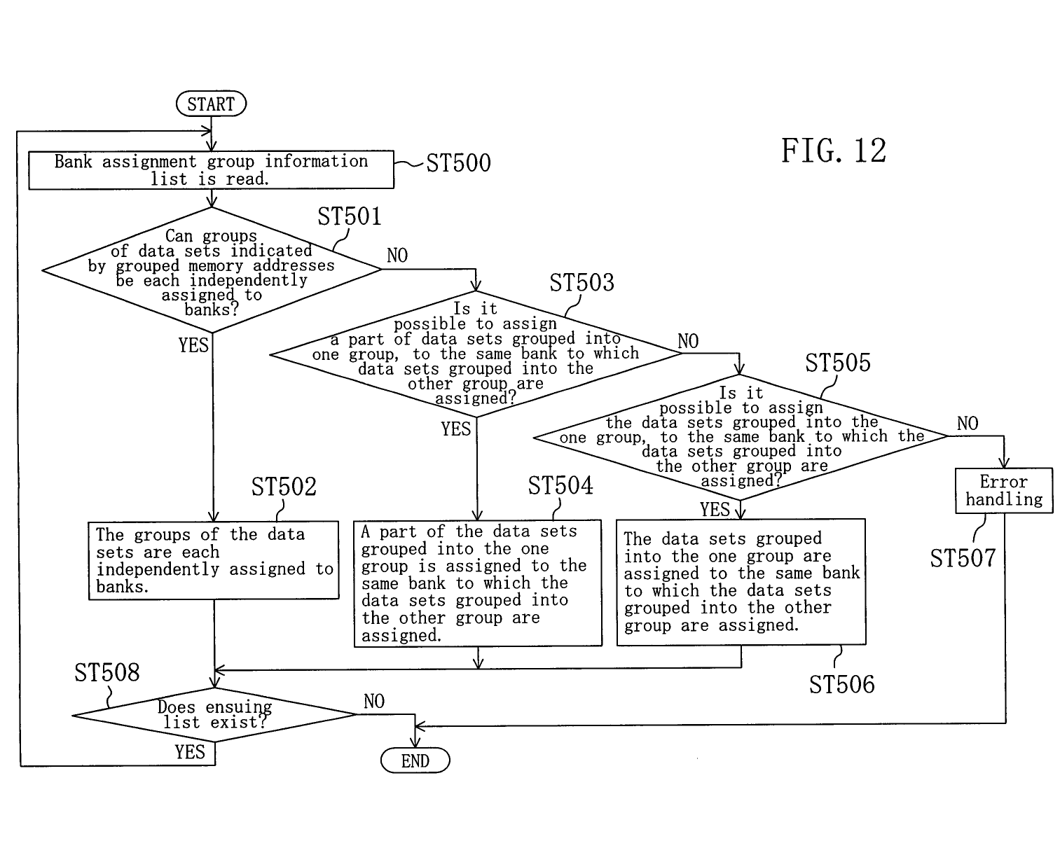

Subsequently, referring to FIG. 12, the bank assignment operation shown in FIG. 11 will be described more specifically. FIG. 12 is a flow chart illustrating the bank assignment operation in which all bank-assignment priority levels among all of the data sets are equal. The flow chart corresponds to the operation of Step ST405 in FIG. 10.

In Step ST500, the bank assignment group information list is read from the head.

In Step ST501, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment group information sets.

If it has been determined in Step ST501 that such independent assignment to the banks is possible, then in Step ST502 the groups of the data sets indicated by the grouped memory addresses are each independently assigned to their respective banks. In each of the read bank assignment group information sets, if the data sets indicated by the grouped memory addresses include a data set which has already been assigned to a bank, the other data set which has not yet been assigned to a bank is assigned to the other bank which is different from the bank of the already assigned data set. If the data sets are assigned in Step ST502, no memory bank conflict occurs.

If it has not been determined in Step ST501 that such independent assignment to the banks is possible, then in Step ST503 a determination is made as to whether it is possible to assign all of the data sets to the banks by assigning a part of the data sets that the memory addresses grouped into the one group indicate, to the same bank to which the data sets that the memory addresses grouped into the other group indicate are assigned.

If it has been determined in Step ST503 that it is possible, then in Step ST504 a part of the data sets indicated by the memory addresses grouped into the one group is assigned to the same bank to which the data sets indicated by the memory addresses grouped into the other group are assigned. When the data sets are assigned in Step ST504, memory bank conflict occurs partially.

If it has not been determined in Step ST503 that it is possible, then in Step ST505 a determination is made as to whether it is possible to assign all of the data sets to the banks by assigning the data sets that the memory addresses grouped into the one group indicate, to the same bank to which the data sets that the memory addresses grouped into the other group indicate are assigned.

If it has been determined in Step ST505 that it is possible, then in Step ST506 the data sets indicated by the memory addresses grouped into the one group are assigned to the same bank to which the data sets indicated by the memory addresses grouped into the other group are assigned. When the data sets are assignment in Step ST506, memory bank conflict occurs.

If it has not been determined in Step ST505 that it is possible, then in Step ST507 error handling is performed.

In Step ST508, it is determined whether there exists an ensuing information set in the bank assignment group information list. If it has been determined in Step ST508 that the ensuing information exits, the process returns to Step ST500 to repeat the operations of Step ST500 through Step ST508.

As described above, in the first embodiment, it is possible to assign data sets that are referred to by memory reference instructions, to banks automatically in decreasing order of usage without causing memory bank conflict.

(Second embodiment)

In the first embodiment, bank assignment is performed with the assumption that bank-assignment priority levels among all data sets are equal. In a second embodiment, bank-assignment priority levels are established according to the loop count, and assigning of data sets to banks is performed beginning with data sets with a high bank-assignment priority level. In the second embodiment, bank control process steps are performed as shown in the flow chart of FIG. 6.

Hereinafter, bank control information obtained in the second embodiment will be discussed with reference to FIG. 47B. A bank control information set shown in FIG. 47B is generated each time a memory reference instruction is read. The bank control information set includes information on the addresses of memories in which data sets are stored, information on bank control priority, and address information that indicates a location in which an ensuing bank control information set is to be stored. In this embodiment, bank control priority established in a bank control information set is equal to the loop count indicating how many times the instruction is executed. By holding the address information that indicates the ensuing-bank-control-information-set storage location, all of the bank control information sets are connected in a list structure. The address information that indicates the ensuing-bank-control-information-set storage location is registered at the time that the ensuing bank control information set has been created.

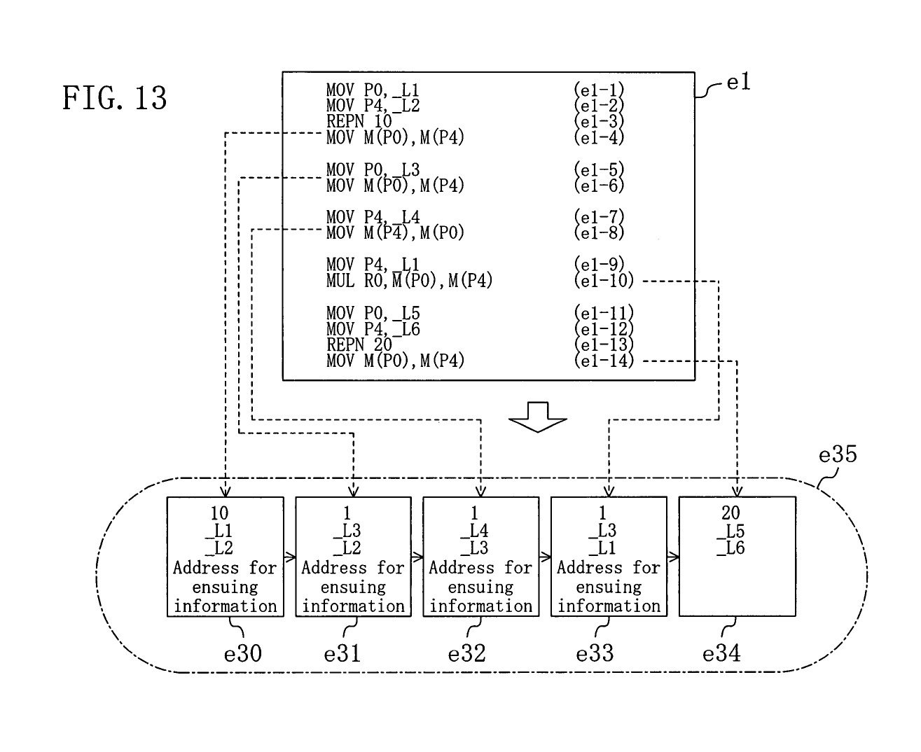

Next, operation for obtaining the bank control information set shown in FIG. 47B will be discussed with reference to FIG. 13.

The reference mark el indicates an example of an input program in which memory reference instructions are written.

The reference mark e30 indicates a bank control information set obtained according to a memory reference instruction e1-4. By the memory reference instruction e1-4, since data L1 and data L2 are referred to simultaneously, the address _L1 of a memory in which the data L1 is stored and the address _L2 of a memory in which the data L2 is stored are registered in memory address information in the bank control information set e30. Since the loop count for the memory reference instruction e1-4 is “10”, which is determined by a loop instruction e1-3, the bank control priority level for the bank control information set e30 is registered as “10”.

The reference mark e31 indicates a bank control information set obtained according to a memory reference instruction e1-6. By the memory reference instruction e1-6, since data L3 and the data L2 are referred to simultaneously, the address _L3 of a memory in which the data L3 is stored and the address _L2 of the memory in which the data L2 is stored are registered in memory address information in the bank control information set e31. Since the memory reference instruction e1-6 is executed one time, the bank control priority level for the bank control information set e31 is registered as “1”. The bank control information set e31 is connected to the bank control information set e30.

The reference mark e32 indicates a bank control information set obtained according to a memory reference instruction e1-8. By the memory reference instruction e1-8, since data L4 and the data L3 are referred to simultaneously, the address _L4 of a memory in which the data L4 is stored and the address _L3 of the memory in which the data L3 is stored are registered in memory address information in the bank control information set e32. Since the memory reference instruction e1-8 is executed one time, the bank control priority level for the bank control information set e32 is registered as “1”. The bank control information set e32 is connected to the bank control information set e31.

The reference mark e33 indicates a bank control information set obtained according to a memory reference instruction e1-10. By the memory reference instruction e1-10, since the data L3 and the data L1 are referred to simultaneously, the address _L3 of the memory in which the data L3 is stored and the address _L1 of the memory in which the data L1 is stored are registered in memory address information in the bank control informtion set e33. Since the memory reference instruction e1-10 is executed one time, the control priority level for the bank control information set e33 is registered as “1”. The bank control information set e33 is connected to the bank control information set e32.

The reference mark e34 indicates a bank control information set obtained according to a memory reference instruction e1-14. By the memory reference instruction e1-14, since data L5 and data L6 are referred to simultaneously, the address _L5 of a memory in which the data L5 is stored and the address _L6 of a memory in which the data L6 is stored are registered in memory address information in the bank control information set e34. Since the loop count for the memory reference instruction e1-14 is “20”, which is determined by a loop instruction e1-13, the bank control priority level for the bank control information set e34 is registered as “20”. The bank control information set e34 is connected to the bank control information set e33.

The above operations produce a bank control information list e35 that includes the bank control information sets e30 through e34.

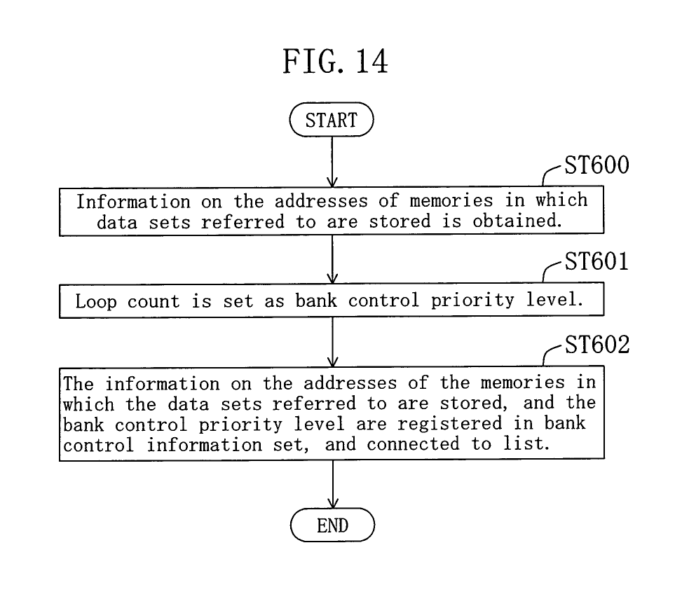

Subsequently, the operation for obtaining the bank control information sets, schematically shown in FIG. 13, will be described more specifically with reference to FIG. 14. FIG. 14 is a flow chart illustrating the operation for obtaining the bank control information set shown in FIG. 47B. The flow chart corresponds to the operation of Step ST201 in FIG. 6.

Step ST600 is to obtain information on the addresses of memories in which data sets to be referred to by a memory reference instruction performed by the arithmetic processing unit 12 are stored.

In Step ST601, a loop count that indicates the number of times the memory reference instruction is executed is set as the bank control priority level.

In Step ST602, the memory address information set obtained in Step ST600 and the bank control priority level obtained in Step ST601 are registered in the corresponding bank control information set, and connected to the bank control information list.

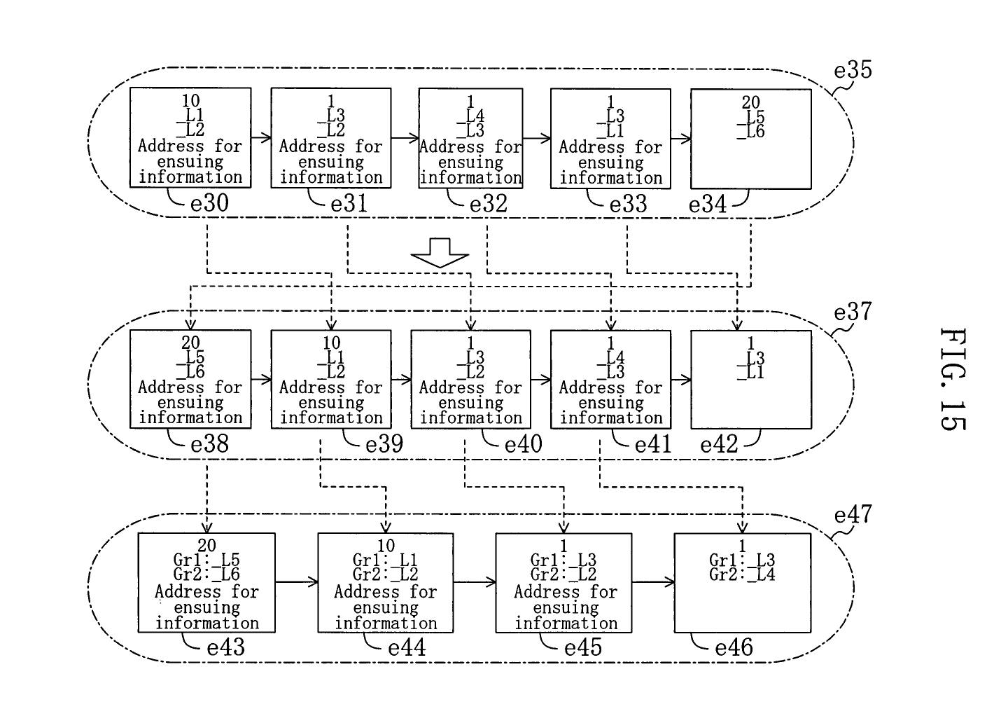

Next, referring to FIG. 15, a bank control method of the second embodiment, in which bank-assignment priority levels are established according to the loop counts, and assigning of data sets to banks is performed beginning with data sets having a high bank-assignment priority level, will be described.

The reference mark e35 indicates a bank control information list.

The reference mark e37 represents a list obtained by rearranging the bank control information list e35 in order of decreasing bank control priority. The reference marks e38 through e42 denote bank control information sets included in the bank control information list e37.

The reference marks e43 through e46 indicate bank assignment group information sets created from the bank control information sets e38 through e42.

Now, bank assignment group information sets produced in the second embodiment will be described with reference to FIG. 48B.

In the second embodiment, bank assignment group information shown in FIG. 48B is generated. Each bank assignment group information set illustrated in FIG. 48B includes: information obtained as a result of the grouping of memory addresses performed based on the bank control information in such a manner that the addresses of memories in which data sets to be assigned to the same bank are stored are grouped into the same group, while the addresses of memories in which data sets to be assigned to different banks are stored are grouped into different groups; information on bank assignment priority; and address information that indicates where the ensuing bank assignment group information set is to be stored. In this embodiment, the number of groups is equal to the number of banks. By holding the address information that indicates the ensuing-bank-assignment-group-information-set storage location, all of the bank assignment group information sets are connected in a list structure. The address information that indicates the ensuing-bank-assignment-group-information-set storage location is registered at the time when the ensuing bank assignment group information set has been created.

Therefore, the bank assignment group information set e43 generated from the bank control information set e38 indicates the results of grouping memories in which data L5 and data L6 are stored, into different groups so that memory addresses _L5 and _L6 registered in memory address information in the bank control information set e38 are grouped into Gr1 and Gr2, respectively. Further, a value registered as the bank control priority level for the bank control information set e38 is registered as the bank assignment priority level.

The bank assignment group information set e44 generated from the bank control information set e39 indicates the results of grouping memories in which data L1 and data L2 are stored, into different groups so that memory addresses _L1 and _L2 registered in memory address information in the bank control information set e39 are grouped into G1 and Gr2, respectively. Further, a value registered as the bank control priority level for the bank control information set e39 is registered as the bank assignment priority level. The bank assignment group information set e44 is connected to the bank assignment group information set e43.

The bank assignment group information set e45 generated from the bank control information set e40 indicates the results of grouping memory addresses _L3 and _L2 that are registered in memory address information in the bank control information set e40. Since the memory address _L2 has already been grouped by the bank assignment group information set e44 into the group Gr2, the memory address _L3 is grouped into Gr1, which is a different group from that of the memory address _L2. Further, a value registered as the bank control priority level for the bank control information set e40 is registered as the bank assignment priority level. The bank assignment group information set e45 is connected to the bank assignment group information set e44.

Likewise, the bank assignment group information set e46 produced from the bank control information set e41 indicates the results of grouping the memory addresses _L3 and _L4 into the groups Gr1 and Gr2, respectively. The bank control priority level for the bank control information set e41 is registered as the bank assignment priority level.

The memory addresses _L3 and _L1 are registered in memory address information in the bank control information set e42. However, at the time that the bank control information set e42 is read, both the memory addresses _L3 and _L1 have already been registered in the bank assignment group information sets, thus eliminating the need for creating a new bank assignment group information set.

The above operations produce a bank assignment group information list e47 that includes the bank assignment group information sets e43 through e46. The banks are assigned in sequence beginning with the data sets indicated by the memory addresses registered in the bank assignment group information set e43 having a high bank assignment priority level.

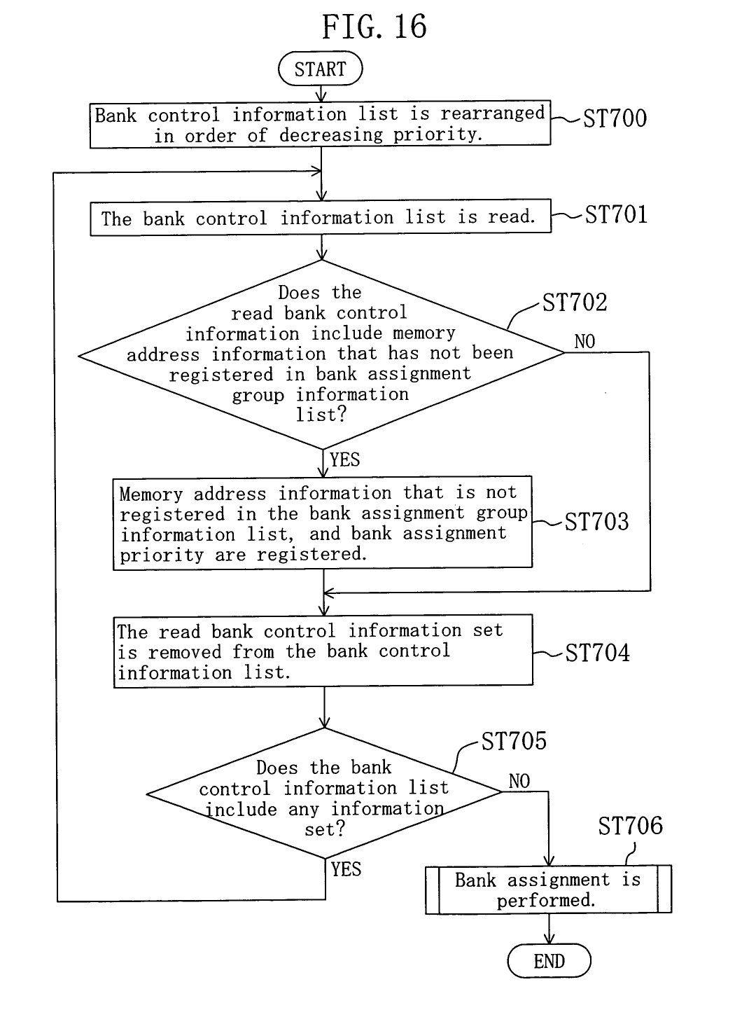

Next, referring to FIG. 16, the bank control method shown in FIG. 15 will be described more specifically. FIG. 16 is a flow chart illustrating the bank control method in which bank-assignment priority levels are set according to the loop counts, and assigning of the data sets to the banks is performed beginning with data sets having a high bankassignment priority level. The flow chart corresponds to the operation of Step ST102 in FIG. 5.

In Step ST700, the bank control information sets in the bank control information list are rearranged in order of decreasing bank-control priority.

In Step ST701, the head of the bank control information list is read.

In Step ST702, a determination is made as to whether the memory addresses indicated by memory address information within the read bank control information set include any memory address which has not yet been registered in the bank assignment group information list.

If it has been determined in Step ST702 that there is such a memory address that has not been registered, then in Step ST703 the unregistered memory address is registered in the bank assignment group information list as a group that is different from a group in which the other memory address that the memory address information within the same bank control information set indicates, has already been registered.

In Step ST704, the read bank control information set is removed from the bank control information list.

In Step ST705, it is determined whether, in the bank control information list, there still remains any bank control information set that has not yet been processed.

If it has been determined in Step ST705 that such a bank control information set remains, the process returns to Step ST701 to repeat the operations of Step ST701 through Step ST705.

If it has been determined in Step ST705 that no such unprocessed bank control information set remains, bank assignment is performed in Step ST706.

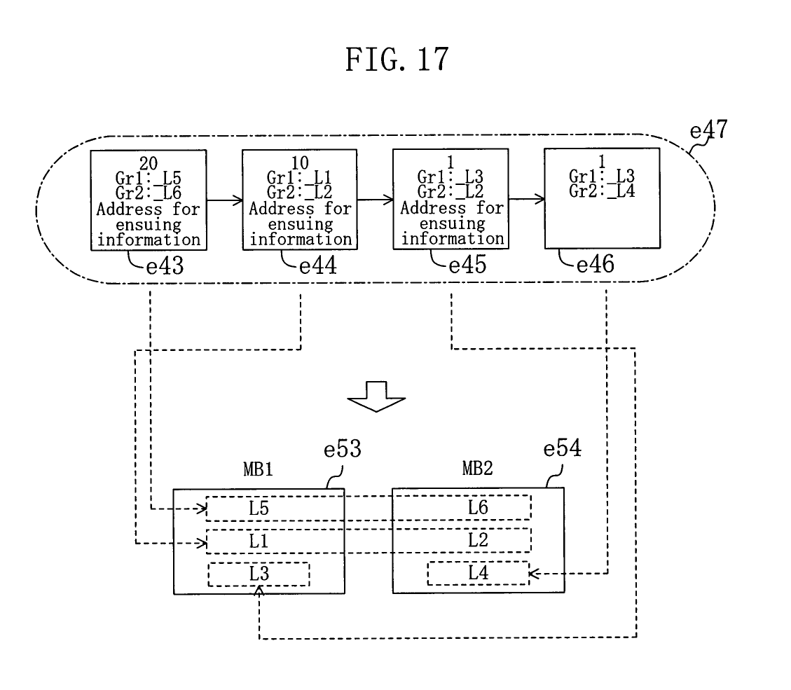

Next, bank assignment operation which corresponds to the operation of Step ST706 in FIG. 16 will be discussed with reference to FIG. 17. FIG. 17 illustrates an exemplary bank assignment operation in which bank assignment priority levels are set according to the loop counts, and assigning of data sets to banks is performed beginning with data sets having a high bank-assignment priority level.

The reference mark e47 denotes a bank assignment group information list. The reference marks e43 through e46 indicate bank assignment group information sets included in the bank assignment group information list e47.

The reference marks e53 and e54 indicate memory banks in which data sets are stored, and show the results of assigning of the data sets to the banks in sequence beginning with the data sets indicated by the memory addresses registered in the bank assignment group information set e43 at the head of the bank assignment group information list. In FIG. 17, data L5, data L1 and data L3 are assigned to the memory bank MB1, while data L6, data L2 and data L4 are assigned to the memory bank MB2. Alternatively, the data L6, data L2 and data L4 may be assigned to the memory bank MB1, whereas the data L5, data L1 and data L3 may be assigned to the memory bank MB2.

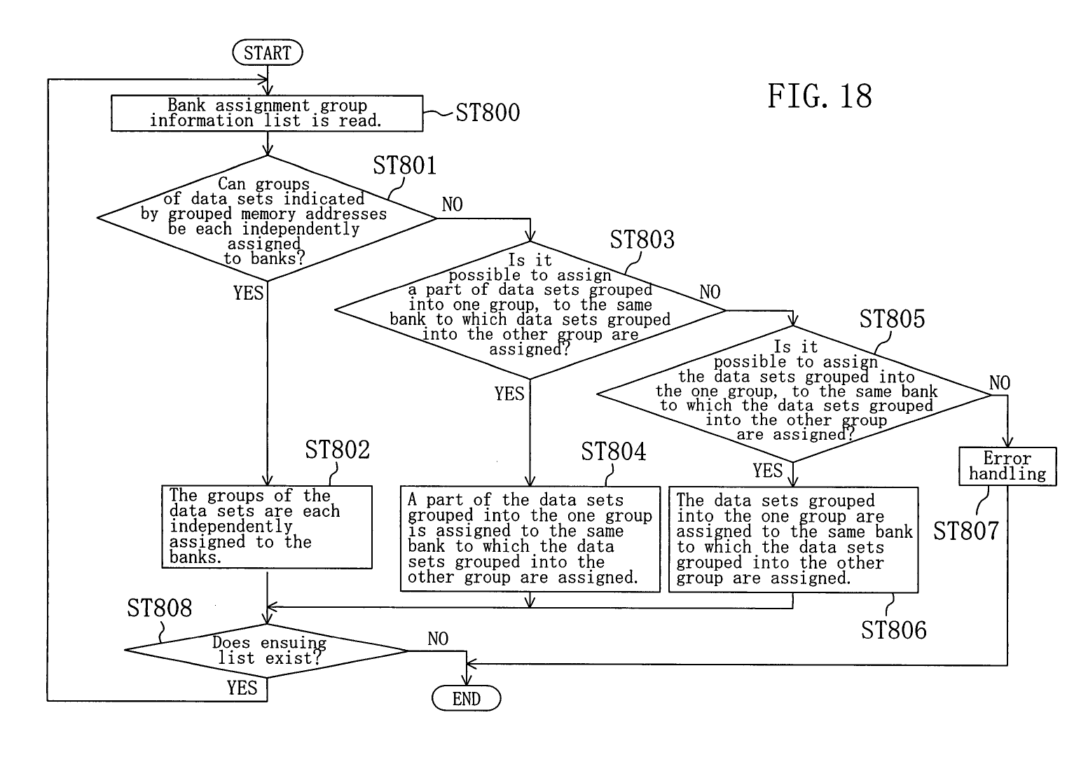

Subsequently, referring to FIG. 18, the bank assignment operation shown in FIG. 17 will be described more specifically. FIG. 18 is a flow chart illustrating the bank assignment operation in which bank-assignment priority levels are set according to the loop counts, and assigning of the data sets to the banks is performed beginning with data sets having a high bank-assignment priority level. The flow chart corresponds to the operation of Step ST706 in FIG. 16.

In Step ST800, the bank assignment group information list is read from the head.

In Step ST801, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment group information sets.

If it has been determined in Step ST801 that such independent assignment is possible, then in Step ST802 the groups of the data sets indicated by the grouped memory addresses are each independently assigned to their respective banks. In each of the read bank assignment group information sets, if the data sets that the grouped memory addresses indicate include a data set that has already been assigned to a bank, the other data set that has not yet been assigned to a bank is assigned to the other bank which is different from the bank of the already assigned data set. If the data sets are assigned in Step ST802, no memory bank conflict occurs.

If it has not been determined in Step ST801 that such independent assignment to the banks is possible, then in Step ST803 a determination is made as to whether it is possible to assign all of the data sets to the banks by assigning a part of the data sets that the memory addresses grouped into the one group indicate, to the same bank to which the data sets that the memory addresses grouped into the other group indicate are assigned.

If it has been determined in Step ST803 that it is possible, then in Step ST804 a part of the data sets indicated by the memory addresses grouped into the one group is assigned to the same bank to which the data sets indicated by the memory addresses grouped into the other group are assigned. When the data sets are assigned in Step ST804, memory bank conflict occurs partially.

If it has not been determined in Step ST803 that it is possible, then in Step ST805 a determination is made as to whether it is possible to assign all of the data sets to the banks by assigning the data sets that the memory addresses grouped into the one group indicate, to the same bank to which the data sets that the memory addresses grouped into the other group indicate are assigned.

If it has been determined in Step ST805 that it is possible, then in Step ST806 the data sets indicated by the memory addresses grouped into the one group are assigned to the same bank to which the data sets indicated by the memory addresses grouped into the other group are assigned. When the data sets are assigned in Step ST806, memory bank conflict occurs.

If it has not been determined in Step ST805 that it is possible, then in Step ST807 error handling is performed.

In Step ST808, it is determined whether there exists an ensuing information set in the bank assignment group information list. If it has been determined in Step ST808 that the ensuing information exits, the process returns to Step ST800 to repeat the operations of Step ST800 through Step ST808.

As described above, in the second embodiment, automatic assignment, to banks, of data sets that are repeatedly used by loop instructions, wherein the greater the loop count of the data set is, the greater the priority with which the data set is assigned, so as not to lead to a memory bank conflict, is possible.

(Third embodiment)

In a third embodiment, bank assignment priority levels are established according to data-use frequency, in which case data having a high bank-assignment priority level and data used simultaneously with such data having a high bank-assignment priority level are assigned preferentially to banks. In the third embodiment, bank control process steps are performed as shown in the flow chart of FIG. 6. Further, bank control information obtained in the third embodiment is the same as the bank control information shown in FIG. 47B, and the method shown in FIG. 13 is used to obtain the bank control information shown in FIG. 47B.

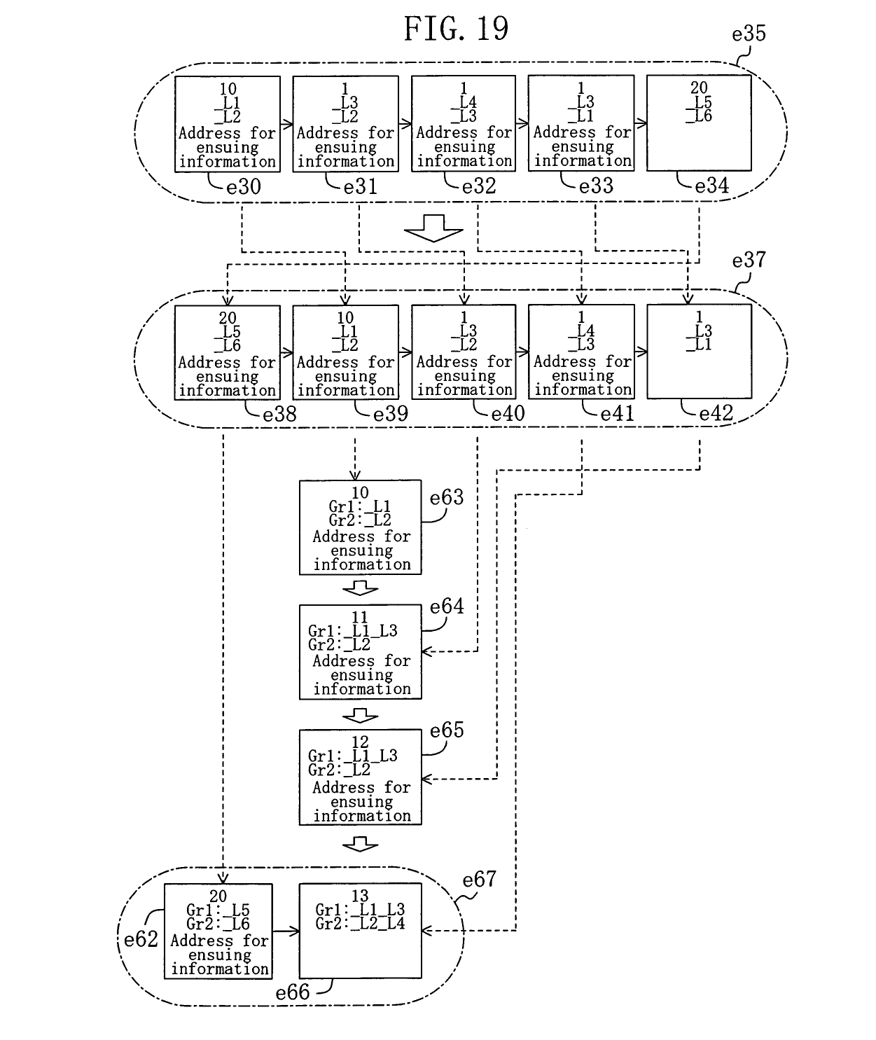

Next, referring to FIG. 19, a bank control method in accordance with the third embodiment will be described. In the bank control method, bank assignment priority levels are established according to data-use frequency, in which case data having a high bank-assignment priority level and data used simultaneously with such data having a high bank-assignment priority level are assigned preferentially to banks.

The reference mark e35 indicates a bank control information list. The reference mark e37 represents a list obtained by sorting the bank control information list e35 in order of decreasing bank-control priority. The reference marks e38 through e42 denote bank control information sets included in the bank control information list e37.

The reference mark e62 indicates a bank assignment group information set created from the bank control information set e38. The reference marks e63 through e66 indicate how bank assignment group information sets produced from the bank control information sets e39 through e42 are completed.

Now, bank assignment group information sets created in the third embodiment will be described with reference to FIG. 48C. In the third embodiment, bank assignment group information shown in FIG. 48C is generated. Each bank assignment group information set illustrated in FIG. 48C includes: information obtained as a result of the grouping of memory addresses performed based on the bank control information in such a manner that the addresses of memories in which data sets to be assigned to the same bank are stored are grouped into the same group, while the addresses of memories in which data sets to be assigned to different banks are stored are grouped into different groups; information on overall bank-assignment priority; and address information that indicates where the ensuing bank assignment group information set is to be stored. In this embodiment, the number of groups is equal to the number of banks. To obtain an overall bank-assignment priority level, each time a bank control information set is processed, a bank control priority level registered in the bank control information set is added. Therefore, bank assignment group information sets in which frequently used data sets are registered are allowed to have a higher overall bank-assignment priority level. Further, by holding the address information that indicates the ensuing-bank-assignment-group-information-set storage location, all of the bank assignment group information sets are connected in a list structure. The address information that indicates the ensuing-bank-assignment-group-information-set storage location is registered at the time when the ensuing bank assignment group information set has been created.

Therefore, the bank assignment group information set e62 generated from the bank control information set e38 indicates the results of grouping of memories in which data L5 and data L6 are stored, into different groups so that memory addresses _L5 and _L6 registered in memory address information in the bank control information set e38 are grouped into Gr1 and Gr2, respectively. Further, a value registered as the bank control priority level for the bank control information set e38 is registered as the overall bank-assignment priority level.

The bank assignment group information set e63 generated from the bank control information set e39 indicates the results of grouping of memories in which data L1 and data L2 are stored, into different groups so that memory addresses _L1 and L2 registered in memory address information in the bank control information set e39 are grouped into Gr1 and Gr2, respectively. Further, a value registered as the bank control priority level for the bank control information set e39 is registered as the overall bank assignment priority level.

The bank assignment group information set e63 is updated to the bank assignment group information set e64 by the bank control information set e40 that has information on the memory address _L2, which has already been grouped in the bank assignment group information set e39. In the bank assignment group information set e64, added is the result of grouping a memory address _L3 into Gr1, which is a different group from Gr2 into which the memory address _L2 has already been grouped. A bank control priority level for the bank control information set e40 is added to the overall bank-assignment priority level for the bank assignment group information set e63, and the resultant value is reregistered as the overall bank-assignment priority level.

The bank assignment group information set e64 is updated to the bank assignment group information set e65 by the bank control information set e42 that has information on the memory address _L1 that has already been grouped in the bank assignment group information set e63. A bank control priority level for the bank control information set e42 is added to the overall bank-assignment priority level for the bank assignment group information set e64, and the resultant value is reregistered as the overall bank-assignment priority level for the bank assignment group information set e65. Since the memory addresses _L3 and _L1 registered in the bank control information set e42 have already been registered in the bank assignment group information sets, no information on the memory addresses is added in the bank assignment group information set e65.

The bank assignment group information set e65 is updated to the bank assignment group information set e66 by the bank control information set e41 that has information on the memory address _L3 that has already been grouped in the bank assignment group information set e64. In the bank assignment group information set e66, added is the result of grouping a memory address _L4 into Gr2, which is a different group from Gr1 into which the memory address _L3 has already been grouped. A bank control priority level for the bank control information set e41 is added to the overall bank-assignment priority level for the bank assignment group information set e65, and the resultant value is reregistered as the overall bank-assignment priority level. The completed bank assignment group information set e66 is connected to the bank assignment group information set e62.

The above operations produce a bank assignment group information list e67 which includes the bank assignment group information sets e62 and e66. The bank assignment group information list e67 is sorted in the order of decreasing overall bank-assignment priority, and assigning of the data sets to banks is performed in sequence beginning with the data sets indicated by the memory addresses registered in the bank assignment group information set having a higher overall bank-assignment priority level.

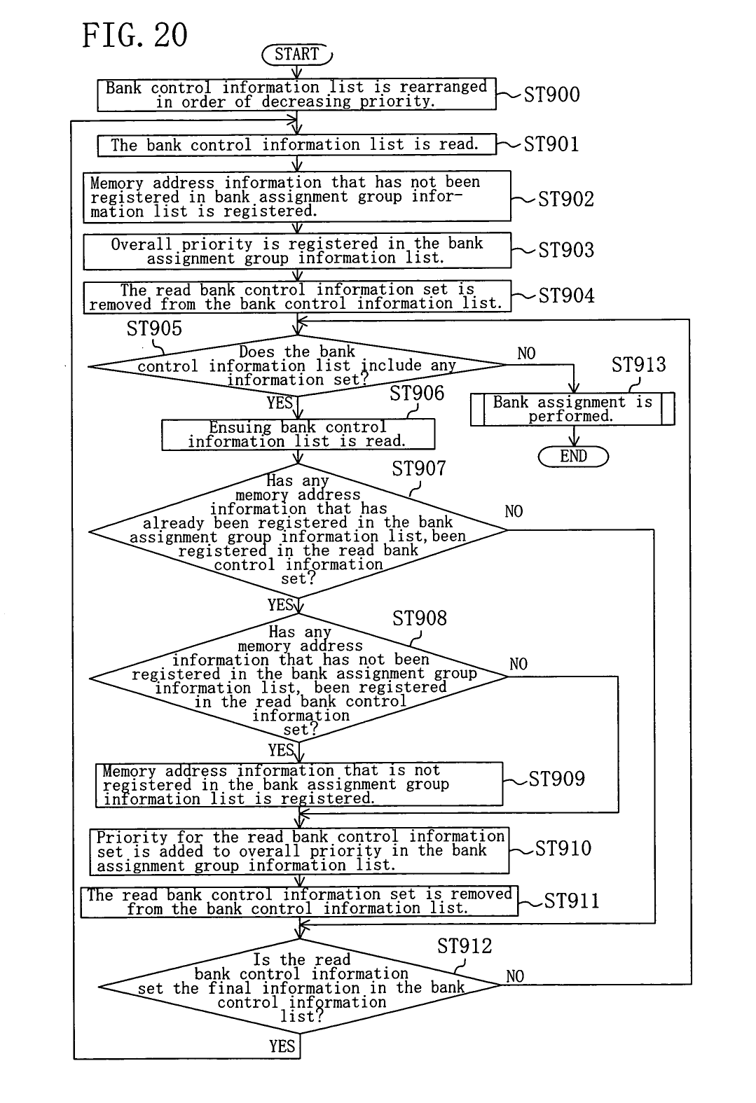

Next, referring to FIG. 20, the bank control method shown in FIG. 19 will be described more specifically. FIG. 20 is a flow chart illustrating the bank control method in which bank assignment priority levels are established according to data-use frequency, and data having a high bank-assignment priority level and data used simultaneously with such data having a high bank-assignment priority level are assigned preferentially to banks. The flow chart corresponds to the operation of Step ST203 in FIG. 6.

In Step ST900, the bank control information sets in the bank control information list are sorted in order of decreasing bank-control priority.

In Step ST901, the head of the bank control information list is read.

In Step ST902, memory addresses that are not registered in the bank assignment group information list are registered in the bank assignment group information list.

In Step ST903, an overall bank-assignment priority level is registered in the bank assignment group information list.

In Step ST904, the read bank control information set is removed from the bank control information list.

In Step ST905, it is determined whether there remains any bank control information set that has not yet been processed, in the bank control information list.

If it has been determined in Step ST905 that such a bank control information set remains, then in Step ST906 the ensuing bank control information set is read from the bank control information list.

In Step ST907, it is determined whether any memory address that has already been registered in the bank assignment group information list has been registered in memory address information in the read bank control information set.

If it has been determined in Step ST907 that such a memory address has been registered, a determination is made in Step ST908 as to whether any memory address that has not been registered in the bank assignment group information list has been registered in the read bank control information set.

If it has been determined in Step ST908 that such a memory address that has not been registered in the bank assignment group information list has been registered in the memory address information in the read bank control information set, then in Step ST909 the memory address that has not been registered in the bank assignment group information list is registered in the bank assignment group information list as a group which is different from a group in which the other memory address that the memory address information in the same bank control information set indicates has already been registered.

In Step ST910, a bank control priority level for the read bank control information set is added to an overall bank-assignment priority level in the bank assignment group information list.

In Step ST911, the read bank control information set is removed from the bank control information list.

In Step ST912, it is determined whether the read bank control information set is the final information in the bank control information list.

If it has been determined in Step ST912 that the read bank control information set is the final information, the process returns to Step ST901. If it has been determined that it is not the final information, the process returns to Step ST905.

If it has been determined in Step ST905 that such a bank control information set that has not been processed does not exist, then in Step ST913 bank assignment is performed.

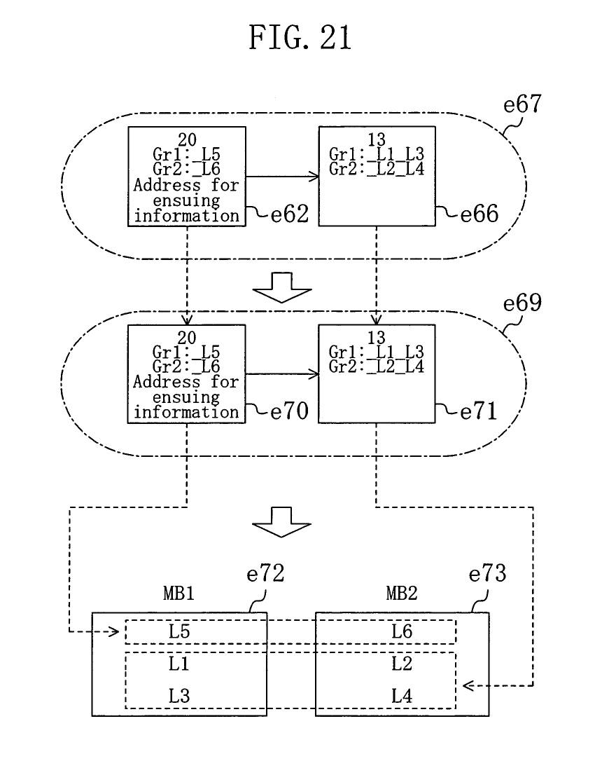

Next, bank assignment operation that corresponds to the operation of Step ST913 in FIG. 20 will be discussed with reference to FIG. 21. FIG. 21 illustrates an exemplary bank assignment operation in which bank assignment priority levels are established according to data-use frequency, and data having a high bank-assignment priority level and data used simultaneously with such data having a high bank-assignment priority level are assigned preferentially to banks.

The reference mark e67 indicates a bank assignment group information list. The reference mark e69 represents a list obtained by sorting the bank assignment group information list e67 in order of decreasing overall bank-assignment priority.

The reference marks e70 and e71 denote bank assignment group information sets included in the bank assignment group information list e69.

The reference marks e72 and e73 indicate memory banks in which data sets are stored, and show the result of assigning the data sets to the banks in sequence beginning with the data sets stored in the areas indicated by the memory addresses registered in the bank assignment group information set e70 at the head of the bank assignment group information list e69. In FIG. 21, data L5, data L1 and data L3 are assigned to the memory bank MB1, while data L6, data L2 and data L4 are assigned to the memory bank MB2. Alternatively, the data L6, data L2 and data L4 may be assigned to the memory bank MB1, whereas the data L5, data L1 and data L3 may be assigned to the memory bank MB2.

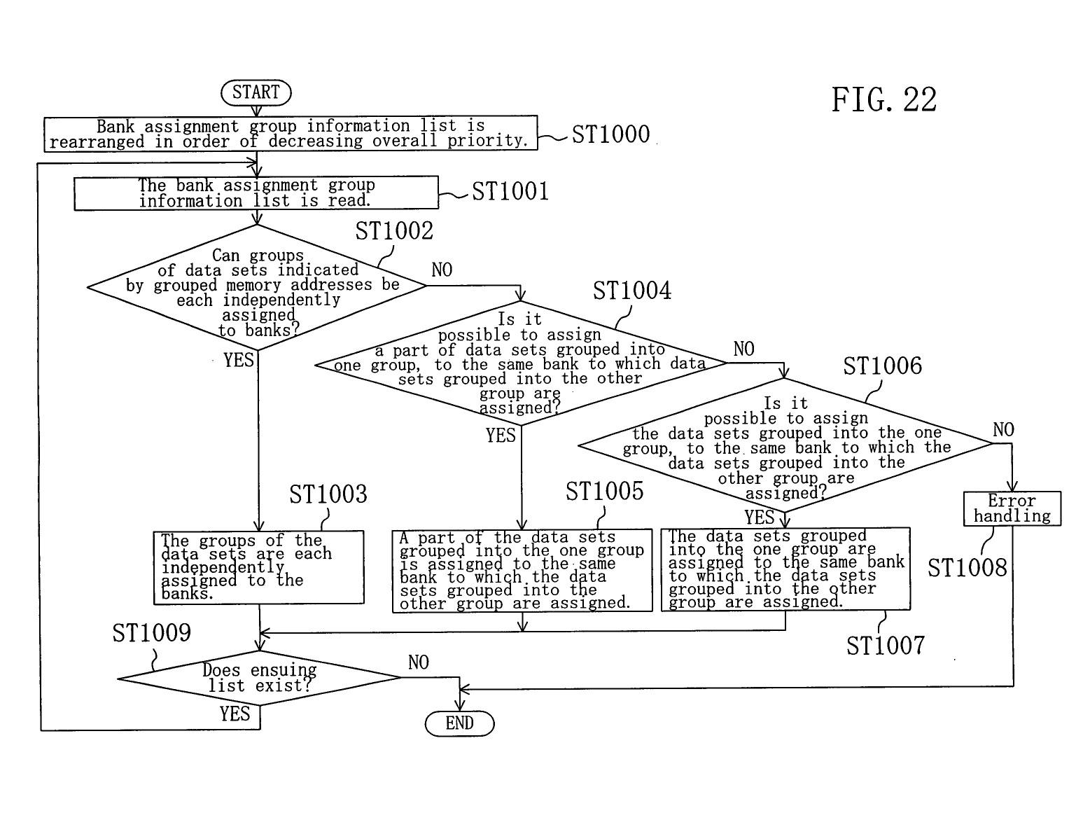

Subsequently, referring to FIG. 22, the bank assignment operation shown in FIG. 21 will be described more specifically. FIG. 22 is a flow chart illustrating the bank assignment operation in which bank assignment priority levels are established according to data-use frequency, and data having a high bank-assignment priority level and data used simultaneously with such data having a high bank-assignment priority level are assigned preferentially to banks. The flow chart corresponds to the operation of Step ST913 in FIG. 20.

In Step ST1000, the bank assignment group information list is sorted in order of decreasing overall bank-assignment priority.

In Step ST1001, the bank assignment group information list is read from the head.

In Step ST1002, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment group information sets.

If it has been determined in Step ST1002 that such independent assignment to the banks is possible, then in Step ST1003 the groups of the data sets indicated by the grouped memory addresses are each independently assigned to their respective banks. In each of the read bank assignment group information sets, if the data sets that the grouped memory addresses indicate include a data set that has already been assigned to a bank, the other data set that has not been assigned to a bank is assigned to the other bank which is different from the bank of the already assigned data set. When the data sets are assigned in Step ST1003, no memory bank conflict occurs.

If it has not been determined in Step ST1002 that such independent assignment to the banks is possible, then in Step ST1004 a determination is made as to whether it is possible to assign all of the data sets to the banks by assigning a part of the data sets that the memory addresses grouped into the one group indicate, to the same bank to which the data sets that the memory addresses grouped into the other group indicate are assigned.

If it has been determined in Step ST1004 that it is possible to assign all of the data sets to the banks by assigning a part of the data sets that the memory addresses grouped into the one group indicate, to the same bank to which the data sets that the memory addresses grouped into the other group indicate are assigned, then in Step ST1005 a part of the data sets that the memory addresses grouped into the one group indicate is assigned to the same bank to which the data sets that the memory addresses grouped into the other group indicate are assigned. When the data sets are assigned in Step ST1005, memory bank conflict occurs partially.

If it has not been determined in Step ST1004 that it is possible assign all of the data sets to the banks by assigning a part of the data sets that the memory addresses grouped into the one group indicate, to the same bank to which the data sets that the memory addresses grouped into the other group indicate are assigned, then in Step ST1006 a determination is made as to whether it is possible to assign all of the data sets to the banks by assigning the data sets that the memory addresses grouped into the one group indicate, to the same bank to which the data sets that the memory addresses grouped into the other group indicate are assigned.

If it has been determined in Step ST1006 that it is possible to assign all of the data sets to the banks by assigning the data sets that the memory addresses grouped into the one group indicate, to the same bank to which the data sets that the memory addresses grouped into the other group indicate are assigned, then in Step ST1007 the data sets indicated by the memory addresses grouped into the one group are assigned to the same bank to which the data sets indicated by the memory addresses grouped into the other group are assigned. When the data sets are assigned in Step ST1007, memory bank conflict occurs.

If it has not been determined in Step ST1006. that it is possible to assign all of the data sets to the banks by assigning the data sets that the memory addresses grouped into the one group indicate, to the same bank to which the data sets that the memory addresses grouped into the other group indicate are assigned, then in Step ST1008 error handling is performed.

In Step ST1009, it is determined whether there exists an ensuing information set in the bank assignment group information list.

If it has been determined in Step ST1009 that the ensuing information exits, the process returns to Step ST1001 to repeat the operations of Step ST1001 through Step ST1009.

As described above, in the third embodiment, frequently used data sets and data sets used simultaneously with such frequently used data sets are assigned preferentially to banks in an automatic manner without causing memory bank conflict. This allows all the data sets to be assigned evenly to the banks without causing memory bank conflict.

(Fourth embodiment)

In a fourth embodiment, bank assignment priority levels are established according to data-use frequency, in which case data sets having a high bank-assignment priority level and data sets used simultaneously with such high-bank-assignment-priority-level data sets are assigned preferentially to banks, and meanwhile, the assigning of the data sets that are used simultaneously with the high-bank-assignment-priority-level data sets, to the banks is also performed in sequence beginning with data sets having a high bank assignment priority level. In the fourth embodiment, bank control process steps are performed as shown in the flow chart of FIG. 5. Further, bank control information obtained in the fourth embodiment is the same as the bank control information shown in FIG. 47B, and the method shown in FIG. 13 is used to obtain the bank control information shown in FIG. 47B.

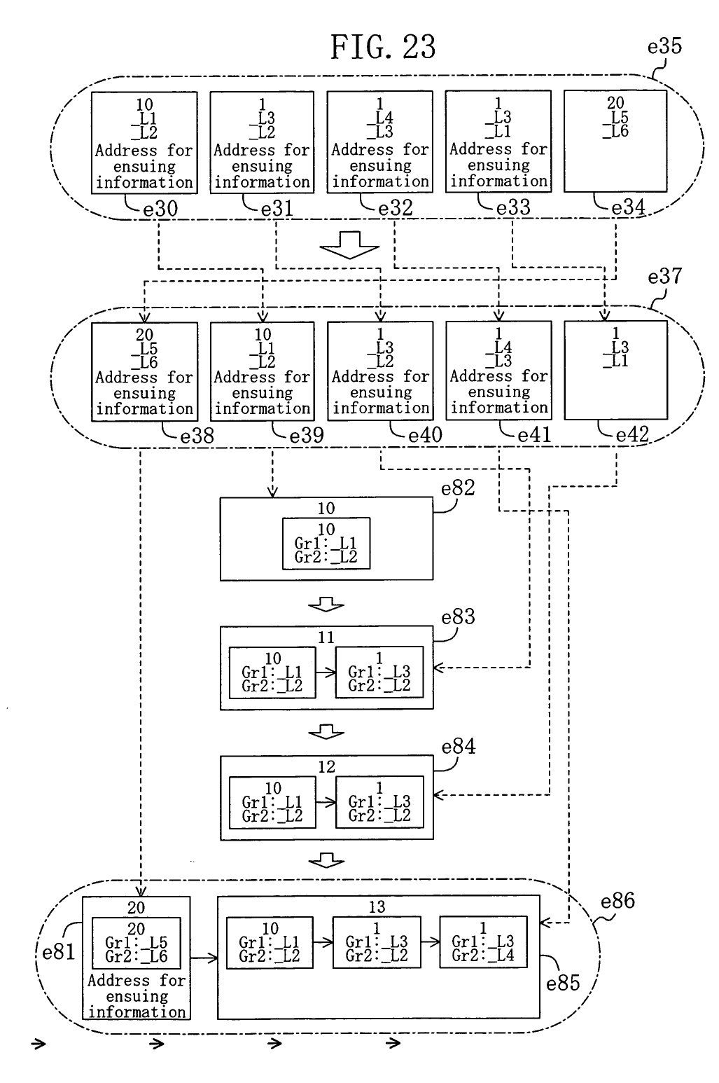

Next, referring to FIG. 23, a bank control method in accordance with the fourth embodiment will be described. In the bank control method, bank assignment priority levels are established according to data-use frequency, in which case data sets having a high bank-assignment priority level and data sets used simultaneously with such highbank-assignment-priority-level data sets are assigned preferentially to banks, and meanwhile, the assigning of the data sets that are used simultaneously with the high-bank-assignment-priority-level data sets, to the banks is also performed in sequence beginning with data sets having a high bank assignment priority level.

The reference mark e35 indicates a bank control information list. The reference mark e37 represents a list obtained by sorting the bank control information list e35 in order of decreasing bank-control priority. The reference marks e38 through e42 denote bank control information sets included in the bank control information list e37.

The reference mark e81 indicates a bank assignment group information set created from the bank control information set e38. The reference marks e82 through e85 indicate how bank assignment group information sets produced from the bank control information sets e39 through e42 are completed.

Now, bank assignment group information sets created in the fourth embodiment will be described with reference to FIG. 48D. In the fourth embodiment, bank assignment group information shown in FIG. 48D is generated.

Each bank assignment group information set illustrated in FIG. 48D includes: information obtained as a result of the grouping of memory addresses performed based on the bank control information set in such a manner that the addresses of memories in which data sets to be assigned to the same bank are stored are grouped into the same group, while the addresses of memories in which data sets to be assigned to different banks are stored are grouped into different groups; information on overall bank-assignment priority; and information that indicates where the ensuing bank assignment group information set is to be stored. In this embodiment, the information on the memory addresses grouped based on the bank control information sets takes the form of bank assignment information 1, bank assignment information 2, bank assignment information m according to the bank control information sets. Each bank assignment information includes a priority level for the memory addresses registered therein. In this embodiment, the number of groups is equal to the number of banks. To obtain an overall bank-assignment priority level, each time a bank control information set is processed, a bank control priority level registered in the bank control information set is added. Therefore, bank assignment group information sets in which frequently used data sets are registered are allowed to have a higher overall bank-assignment priority level. Further, by holding the address information that indicates the ensuing-bank-assignment-group-information-set storage location, all of the bank assignment group information sets are connected in a list structure. The address information that indicates the ensuing-bank-assignment-group-information-set storage location is registered at the time when the ensuing bank assignment group information set has been created.

Therefore, the bank assignment group information set e81 generated from the bank control information set e38 indicates in its bank assignment information 1 the results of grouping memories in which data L5 and data L6 are stored, into different groups so that memory addresses _L5 and _L6 registered in memory address information in the bank control information set e38 are grouped into Gr1 and Gr2, respectively. Further, a bank control priority level for the bank control information set e76 is registered as a priority level for the bank assignment information 1. And, the bank control priority level for the bank control information set e76 is registered as the overall bank-assignment priority level.

The bank assignment group information set e82 generated from the bank control information set e39 indicates in its bank assignment information 1 the results of grouping memories in which data L1 and data L2 are stored, into different groups so that memory addresses _L1 and _L2 registered in memory address information in the bank control information set e39 are grouped into Gr1 and Gr2, respectively. A bank control priority level for the bank control information set e39 is registered as a priority level for the bank assignment information 1. And the bank control priority level for the bank control information set e39 is registered as the overall bank assignment priority level.

The bank assignment group information set e82 is updated to the bank assignment group information set e83 by the bank control information set e40 that has information on the memory address _L2 which has already been grouped in the bank assignment group information set e82. In the bank assignment group information set e83, added as bank assignment information 2 is the result of grouping a memory address _L3 into Gr1, which is a different group from Gr2 into which the memory address _L2 has already been grouped. A bank control priority level for the bank control information set e40 is registered as a priority level for the bank assignment information 2. Further, the value obtained by adding the bank control priority level for the bank control information set e40 to the overall bank assignment priority level for the bank assignment group information set e82 is reregistered as the overall bank assignment priority level.

The bank assignment group information set e83 is updated to the bank assignment group information set e84 by the bank control information set e42 that has information on the memory address _L1 that has already been grouped in the bank assignment group information set e82. The value obtained by adding a bank control priority level for the bank control information set e42 to the overall bank-assignment priority level for the bank assignment group information set e83 is reregistered as the overall bank-assignment priority level for the bank assignment group information set e84. Since the memory addresses _L3 and _L1 registered in the bank control information set e42 have already been registered in the bank assignment group information set, no bank assignment information is added in the bank assignment group information set e84.

The bank assignment group information set e84 is updated to the bank assignment group information set e85 by the bank control information set e41 that has information on the memory address _L3 that has already been grouped in the bank assignment group information set e83. In the bank assignment group information set e85, added as bank assignment information 3 is the result of grouping a memory address _L4 into the group Gr2, which is a different group from Gr1 into which the memory address _L3 has already been grouped. A bank control priority level for the bank control information set e41 is registered as a priority level for the bank assignment information 3. Further, the value obtained by adding the priority level for the bank control information set e41 to the overall priority level for the bank assignment group information set e84 is reregistered as the overall bank assignment priority level. The bank assignment group information set e85 completed in this manner is connected to the bank assignment group information set e81.

The above operations produce a bank assignment group information list e86 which includes the bank assignment group information sets e81 and e85. The bank assignment group information list e86 is sorted in the order of decreasing overall bank-assignment priority, and assigning of the data sets to banks is performed in sequence beginning with the data sets indicated by the memory addresses registered in the bank assignment information 1 in the bank assignment group information set with a high overall bankassignment priority level.

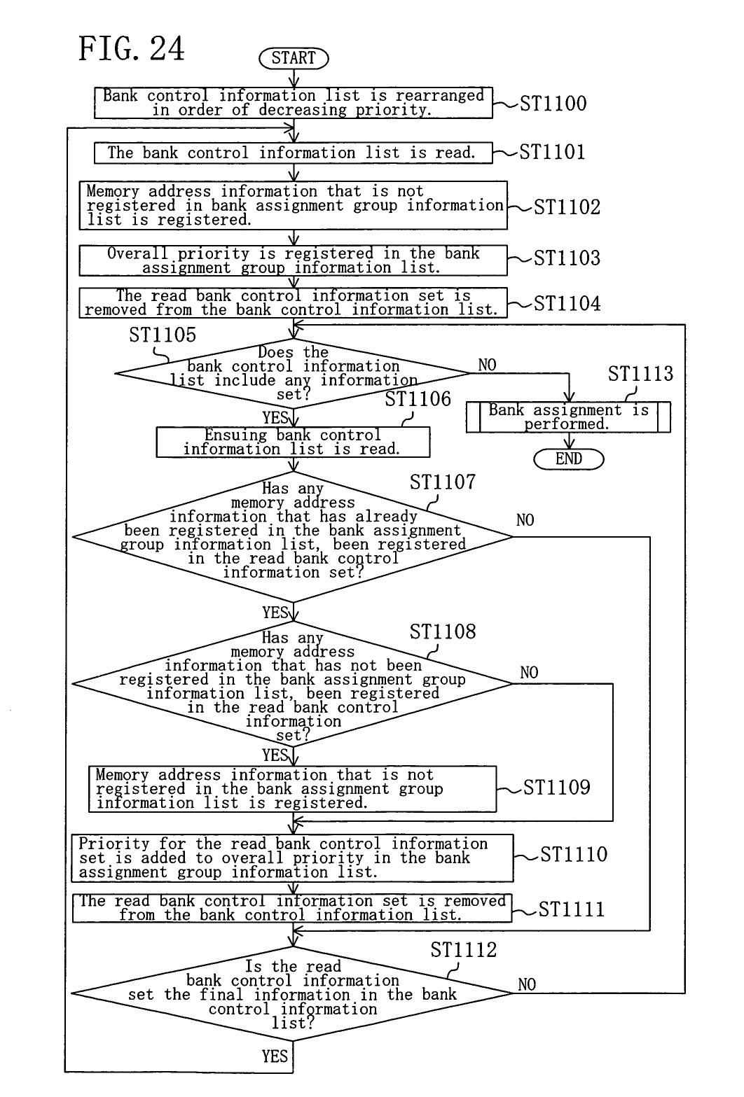

Next, referring to FIG. 24, the bank control method shown in FIG. 23 will be described more specifically. FIG. 24 is a flow chart illustrating the bank control method in which bank assignment priority levels are established according to data-use frequency, in which case data sets having a high bank-assignment priority level and data sets used simultaneously with such high-bank-assignment-priority-level data sets are assigned preferentially to banks, and meanwhile, the assigning of the data sets that are used simultaneously with the high-bank-assignment-priority-level data sets, to the banks is also performed in sequence beginning with data sets having a high bank assignment priority level. The flow chart corresponds to the operation of Step ST102 in FIG. 5.

In Step ST1100, the bank control information sets in the bank control information list are sorted in order of decreasing bank-control priority.

In Step ST1101, the head of the bank control information list is read.

In Step ST1102, memory addresses that are not registered in the bank assignment group information list are registered in the bank assignment group information list.

In Step ST1103, an overall bank-assignment priority level is registered in the bank assignment group information list.

In Step ST1104, the read bank control information set is removed from the bank control information list.

In Step ST1105, it is determined whether there remains any bank control information set that has not yet been processed, in the bank control information list.

If it has been determined in Step ST1105 that such a bank control information set that has not been processed remains, then in Step ST1106 the ensuing bank control information set is read from the bank control information list.

In Step ST1107, it is determined whether any memory address that has already been registered in the bank assignment group information list has been registered in memory address information within the read bank control information set.

If it has been determined in Step ST1107 that such a memory address that has already been registered in the bank assignment group information list has been registered in the memory address information within the read bank control information set, then a determination is made in Step ST1108 as to whether any memory address that has not been registered in the bank assignment group information list has been registered in the bank control information set.

If it has been determined in Step ST1108 that such a memory address that has not been registered in the bank assignment group information list has been registered in the memory address information in the bank control information set, then in Step ST1109 the memory address that has not been registered in the bank assignment group information list is registered in the bank assignment group information list as a group which is different from a group in which the other memory address that the memory address information in the same bank control information set indicates has already been registered.

In Step ST1110, a bank control priority level for the read bank control information set is added to an overall bank-assignment priority level in the bank assignment group information list.

In Step ST1111, the read bank control information set is removed from the bank control information list.

In Step ST1112, it is determined whether the read bank control information set is the final information in the bank control information list.

If it has been determined in Step ST1112 that the read bank control information set is the final information, the process returns to Step ST1101. If it has been determined that it is not the final information, the process returns to Step ST1105.

If it has been determined in Step ST1105 that such a bank control information set that has not been processed does not remain, then in Step ST1113 bank assignment is performed.

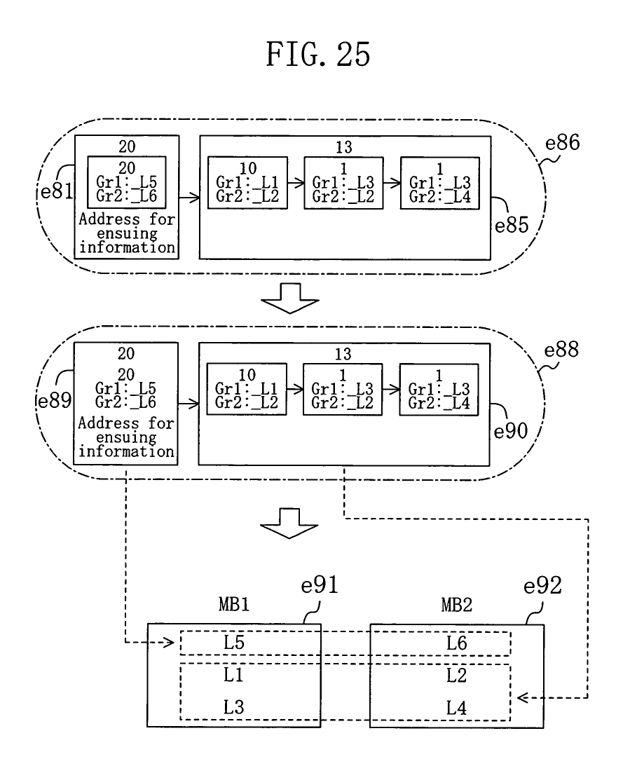

Next, bank assignment operation that corresponds to the operation of Step ST1113 in FIG. 24 will be discussed with reference to FIG. 25. FIG. 25 illustrates an exemplary bank assignment operation in which bank assignment priority levels are established according to data-use frequency, in which case data sets having a high bank-assignment priority level and data sets used simultaneously with such high-bank-assignment-priority-level data sets are assigned preferentially to banks, and meanwhile, the assigning of the data sets that are used simultaneously with the high-bank-assignment-priority-level data sets, to the banks is also performed in sequence beginning with data sets having a high bank assignment priority level.

The reference mark e86 indicates a bank assignment group information list. The reference mark e88 represents a list obtained by sorting the bank assignment group information list e86 in order of decreasing overall bank-assignment priority. The reference marks e89 and e90 denote bank assignment group information sets included in the bank assignment group information list e88.

The reference marks e91 and e92 indicate memory banks in which data sets are stored, and show the result of assigning the data sets to the banks in sequence beginning with the data sets stored in the areas indicated by the memory addresses registered in the bank assignment group information set e89 at the head of the bank assignment group information list e88. In FIG. 25, data L5, data L1 and data L3 are assigned to the memory bank MB1, while data L6, data L2 and data L4 are assigned to the memory bank MB2. Alternatively, the data L6, data L2 and data L4 may be assigned to the memory bank MB1, whereas the data L5, data L1 and data L3 may be assigned to the memory bank MB2.

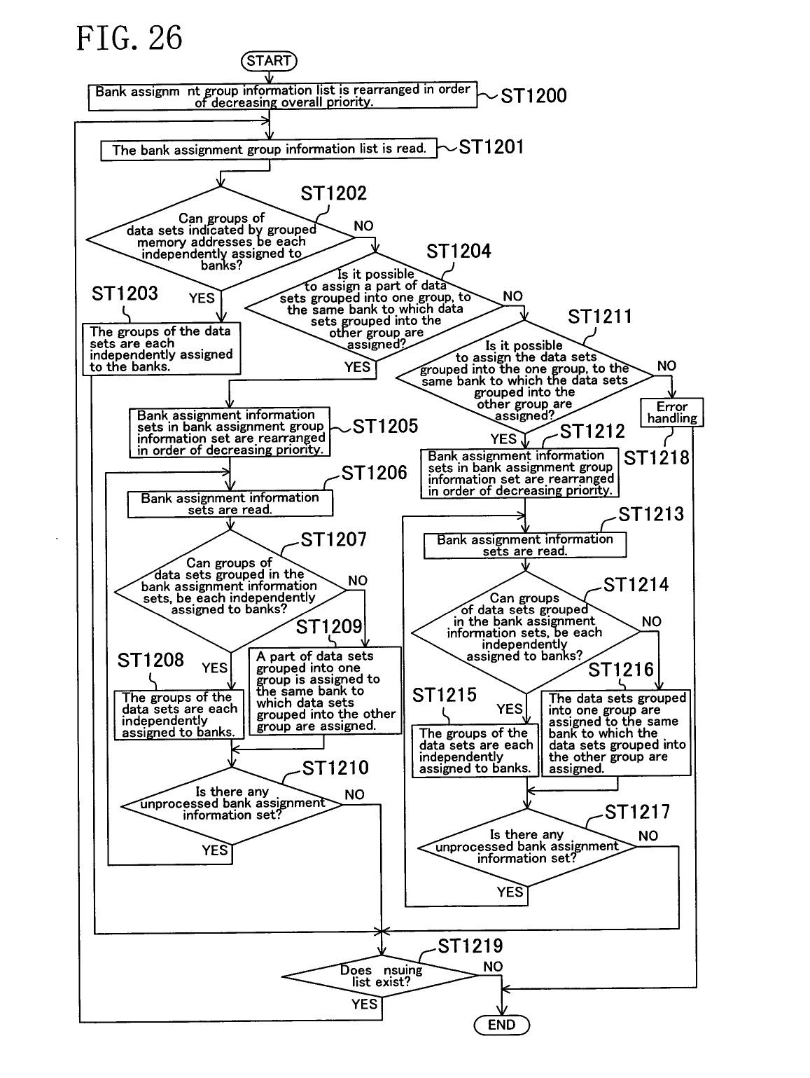

Subsequently, referring to FIG. 26, the bank assignment operation shown in FIG. 25 will be described more specifically. FIG. 26 is a flow chart illustrating the bank control operation in which bank assignment priority levels are established according to data-use frequency, in which case data sets having a high bank-assignment priority level and data sets used simultaneously with such high-bank-assignment-priority-level data sets are assigned preferentially to banks, and meanwhile, the assigning of the data sets that are used simultaneously with the high-bank-assignment-priority-level data sets, to the banks is also performed in sequence beginning with data sets having a high bank assignment priority level. The flow chart corresponds to the operation of Step ST1113 in FIG. 24.

In Step ST1200, the bank assignment group information list is sorted in order of decreasing overall bank-assignment priority.

In Step ST1201, the bank assignment group information list is read from the head.

In Step ST1202, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment group information sets.

If it has been determined in Step ST1202 that such independent assignment to the banks is possible, then in Step ST1203 the groups of the data sets indicated by the grouped memory addresses are each independently assigned to their respective banks. In each of the read bank assignment group information sets, if the data sets that the grouped memory addresses indicate include a data set that has already been assigned to a bank, the other data set that has not been assigned to a bank is assigned to the other bank which is different from the bank of the already assigned data set. When the data sets are assigned in Step ST1203, no memory bank conflict occurs.

If it has not been determined in Step ST1202 that such independent assignment to the banks is possible, then in Step ST1204 a determination is made as to whether it is possible to assign all of the data sets to the banks by assigning a part of the data sets that the memory addresses grouped into the one group indicate, to the same bank to which the data sets that the memory addresses grouped into the other group indicate are assigned.

If it has been determined in Step ST1204 that it is possible to assign all of the data sets to the banks by assigning a part of the data sets that the memory addresses grouped into the one group indicate, to the same bank to which the data sets that the memory addresses grouped into the other group indicate are assigned, then in Step ST1205 the bank assignment information sets within a bank assignment group information set are rearranged in order of decreasing priority.

In Step ST1206, the bank assignment information sets are read from the head.

In Step ST1207, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment information sets.

If it has been determined in Step ST1207 that such independent assignment to the banks is possible, then in Step ST1208 the groups of the data sets indicated by the grouped memory addresses are each independently assigned to their respective banks. In each of the read bank assignment information sets, if the data sets that the grouped memory addresses indicate include a data set that has already been assigned to a bank, the other data set that has not been assigned to a bank is assigned to the other bank which is different from the bank of the already assigned data set.

If it has not been determined in Step ST1207 that such independent assignment to the banks is possible, then in Step ST1209 a part of the data sets that the memory addresses grouped into the one group indicate is assigned to the same bank to which the data sets that the memory addresses grouped into the other group indicate are assigned.

In Step ST1210, it is determined whether there exists any bank assignment information set that has not been processed, in the bank assignment group information set.

If it has been determined in Step ST1210 that such a bank assignment information set exits, the process returns to Step ST1206 to repeat the operations of Step ST1206 through Step ST1210. If the data sets are assigned in Steps ST1205 through ST1210, memory bank conflict occurs partially.

If it has not been determined in Step ST1204 that it is possible to assign all of the data sets to the banks by assigning a part of the data sets that the memory addresses grouped into the one group indicate, to the same bank to which the data sets that the memory addresses grouped into the other group indicate are assigned, then in Step ST1211 a determination is made as to whether it is possible to assign all of the data sets to the banks by assigning the data sets that the memory addresses grouped into the one group indicate, to the same bank to which the data sets that the memory addresses grouped into the other group indicate are assigned.

If it has been determined in Step ST1211 that it is possible to assign all of the data sets to the banks by assigning the data sets that the memory addresses grouped into the one group indicate, to the same bank to which the data sets that the memory addresses grouped into the other group indicate are assigned, then in Step ST1212 the bank assignment information sets within a bank assignment group information set are rearranged in order of decreasing priority.

In Step ST1213, the bank assignment information sets are read from the head.

In Step ST1214, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment information sets.

If it has been determined in Step ST1214 that such independent assignment to the banks is possible, then in Step ST1215 the groups of the data sets indicated by the grouped memory addresses are each independently assigned to their respective banks. In each of the read bank assignment information sets, if the data sets that the grouped memory addresses indicate include a data set that has already been assigned to a bank, the other data set that has not been assigned to a bank is assigned to the other bank which is different from the bank of the already assigned data set.

If it has not been determined in Step ST1214 that such independent assignment to the banks is possible, then in Step ST1216 the data sets that the memory addresses grouped into the one group indicate are assigned to the same bank to which the data sets that the memory addresses grouped into the other group indicate are assigned.

In Step ST1217, it is determined whether there exists any bank assignment information set that has not been processed, in the bank assignment group information set.

If it has been determined in Step ST1217 that such a bank assignment information set exits, the process returns to Step ST1213 to repeat the operations of Step ST1213 through Step ST1217. If the data sets are assigned in Steps ST1212 through ST1217, memory bank conflict occurs.

If it has not been determined in Step ST1211 that it is possible to assign all of the data sets to the banks by assigning the data sets that the memory addresses grouped into the one group indicate, to the same bank to which the data sets that the memory addresses grouped into the other group indicate are assigned, then in Step ST1218 error handling is performed.

In Step ST1219, it is determined whether there exists an ensuing information set in the bank assignment group information list.

If it has been determined in Step ST1219 that the ensuing information exits, the process returns to Step ST1201 to repeat the operations of Step ST1201 through Step ST1219.

As described above, in the fourth embodiment, frequently used data sets and data sets used simultaneously with such frequently used data sets are assigned preferentially to banks in an automatic manner without causing memory bank conflict. This allows all of the data sets to be assigned evenly to the banks without causing memory bank conflict. Further, the assigning of the frequently used data sets and the data sets used simultaneously with the frequently used data sets, to the banks is performed in sequence beginning with data sets having high priority, which permits the data sets having high priority to be assigned to the banks without causing memory bank conflict, even in a case where there is not enough bank capacity.

(Fifth embodiment)

In a fifth embodiment, the functions described in the first through fourth embodiments are supported by user-described bank control instructions.

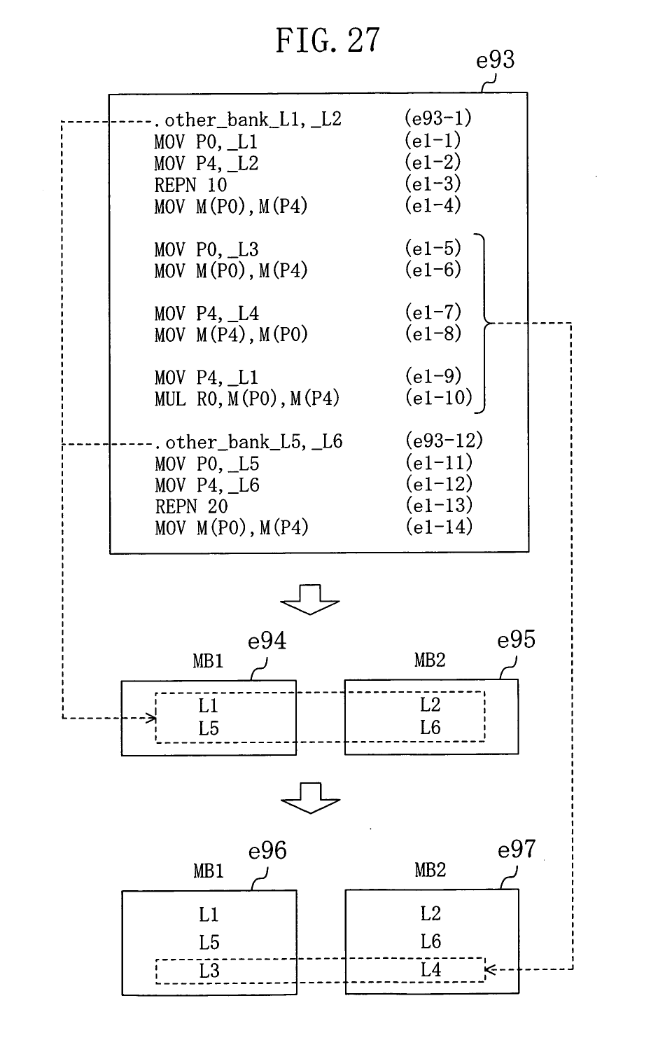

FIG. 27 illustrates an example of bank assignment in which data sets to be assigned to different banks are designated by bank control instructions. The reference mark e93 indicates an example of an input file in which memory reference instructions and bank control instructions are written. The exemplary input file is one obtained by adding bank control instructions e93-1 and e93-12 to the input file e1.

The bank control instruction e93-1 is an instruction that specifies that data sets L1 and L2 are assigned to different banks. The designated data sets L1 and L2 are assigned preferentially to the different banks.

The bank control instruction e93-12 is an instruction that specifies that data sets L5 and L6 are assigned to different banks. The designated data sets L5 and L6 are assigned preferentially to the different banks.

The reference marks e94 and e95 indicate examples of the results of preferentially assigning to the banks the data sets L1, L2, L5, and L6 that are designated by the bank control instructions.

After the data sets designated by the bank control instructions have been assigned to the banks, among the data sets referred to in the input file e93, assigned to the banks are data sets L3 and L4, to which no bank is assigned by the bank control instructions. The reference marks e96 and e97 indicate examples of the memory banks after the data sets that are not designated by the bank control instructions have been assigned to the banks.

Assigning in the above manner to the banks all of the data sets L1 through L6 referred to in the input file e93 results in the memory banks e96 and e97.

Next, it will be described how to perform bank assignment in which bank control instructions such as shown in FIG. 27 are used.

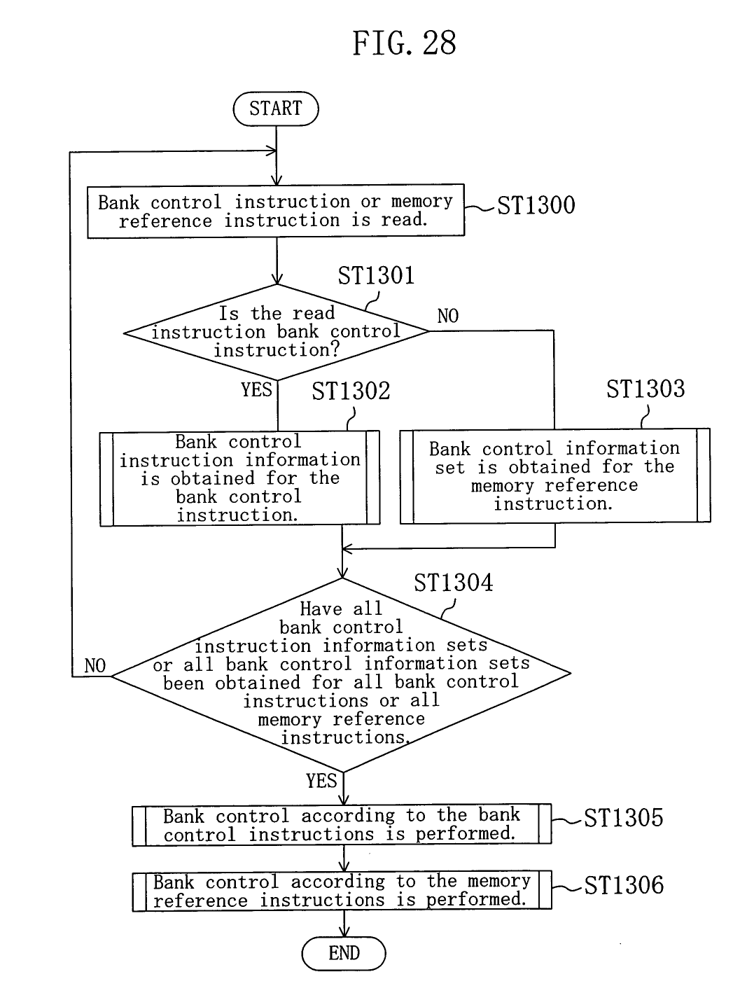

FIG. 28 is a flow chart illustrating process steps in bank control in which bank control instructions designate data sets to be assigned to different banks.

In Step ST1300, a bank control instruction, or a memory reference instruction performed by the arithmetic processing unit 12 is read.

In Step ST1301, it is determined whether the read instruction is a bank control instruction.

If it has been determined in Step ST1301 that the read instruction is a bank control instruction, then in Step ST1302 necessary information for bank control performed according to the bank control instruction (which will be hereinafter referred to as “bank control instruction information”) is obtained for the bank control instruction.

If it has not been determined in Step ST1301 that the read instruction is a bank control instruction, then in Step ST1303 a bank control information set is obtained for the read instruction. The operation in Step ST1303 is performed using the method shown in FIG. 7 or 13.

In Step ST1304, a determination is made as to whether all bank control instruction information sets or all bank control information sets have been obtained for all the bank control instructions or all the memory reference instructions.

If it has not been determined in Step ST1304 that all the information sets have been obtained, the process returns to Step ST1300 to repeat the operations of Step ST1300 through Step ST1304.

If it has been determined in Step ST1304 that all the information sets have been obtained, then in Step ST1305 bank control for the data sets designated by the bank control instructions is performed.

Step ST1306 is a step in which bank control is performed for, among the data sets referred to by the memory reference instructions, data sets that are not designated by the bank control instructions. In this step, any of the methods shown in FIGS. 10, 16, 20, and 24 is used in accordance with the bank control information obtained in Step ST1303.

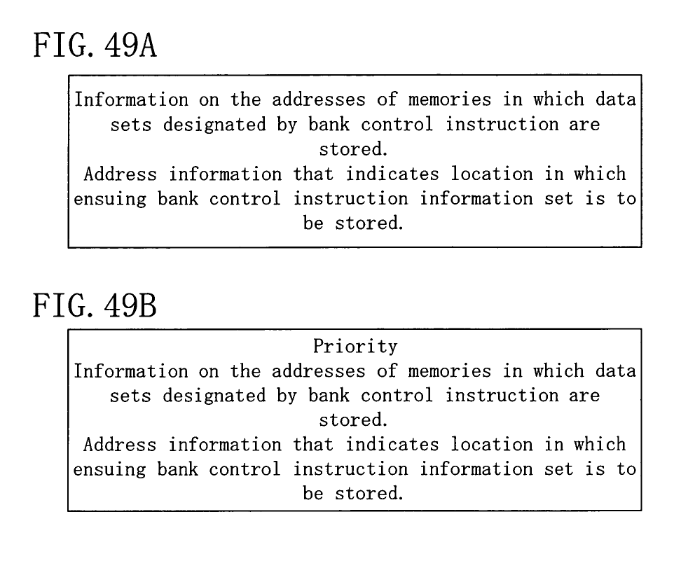

Now, referring to FIG. 49A, the bank control instruction information obtained in the fifth embodiment will be described. A bank control instruction information set shown in FIG. 49A is generated each time a bank control instruction is read. The bank control instruction information set includes information on the addresses of memories in which data sets designated by the bank control instruction are stored, and address information that indicates a location in which an ensuing bank control instruction information set is to be stored. By holding the address information that indicates the ensuing-bank-controlinstruction-information-set storage location, all of the bank control instruction information sets are connected in a list structure. The address information that indicates the ensuing-bank-control-instruction-information-set storage location is registered at the time that the ensuing bank control instruction information set has been created.

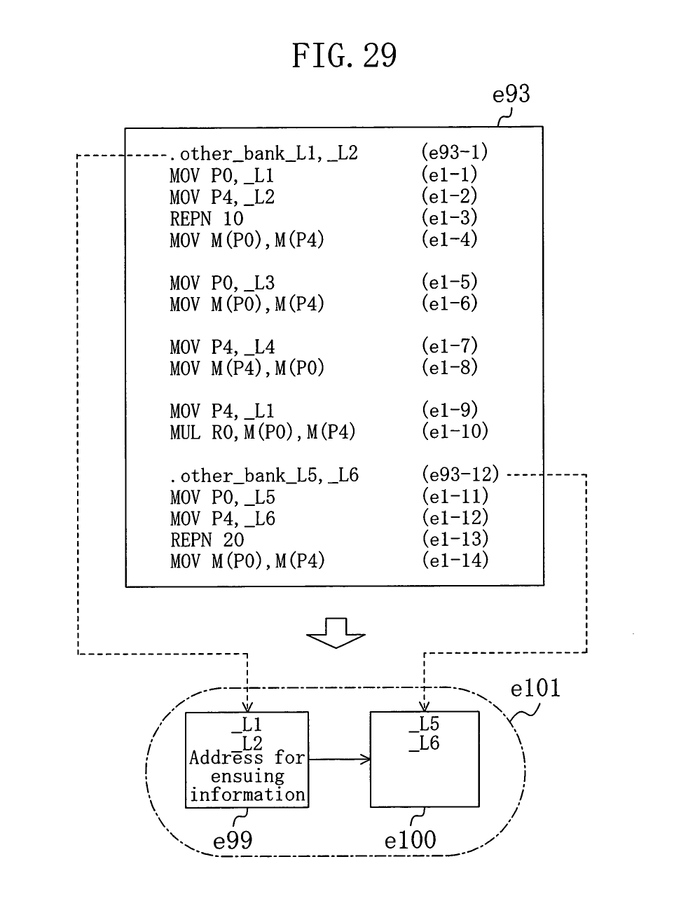

Next, operation for obtaining the bank control instruction information set shown in FIG. 49A will be discussed with reference to FIG. 29.

The reference mark e93 indicates an example of an input program in which memory reference instructions and bank control instructions are written. The reference mark e99 indicates a bank control instruction information set obtained in accordance with a bank control instruction e93-1. Since the bank control instruction e93-1 specifies that data L1 and data L2 are assigned to different banks, the address _L1 of a memory in which the data L1 is stored and the address _L2 of a memory in which the data L2 is stored are registered in memory address information in the bank control instruction information set e99.

The reference mark e100 indicates a bank control instruction information set obtained according to a bank control instruction e93-12. Since the bank control instruction e93-12 specifies that data L5 and data L6 are assigned to different banks, the address _L5 of a memory in which the data L5 is stored and the address _L6 of a memory in which the data L6 is stored are registered in memory address information in the bank control instruction information set e100. The bank control instruction information set e100 is connected to the bank control instruction information set e99.

The above operations produce a bank control instruction information list e111 that includes the bank control instruction information sets e99 and e100.

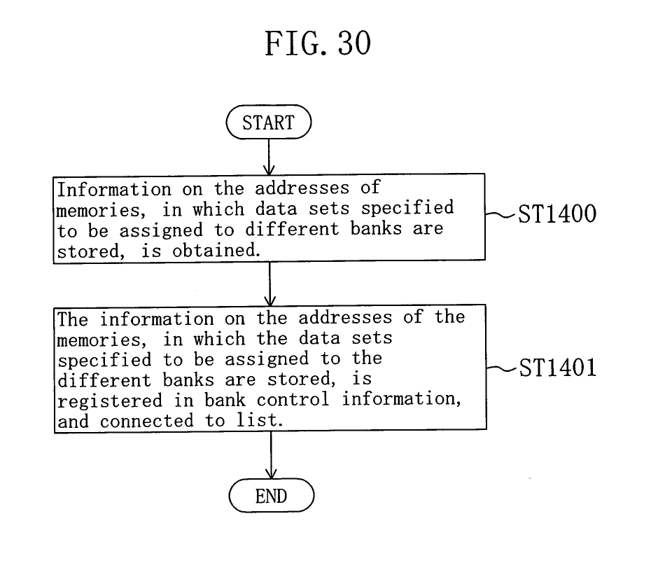

Subsequently, the operation for obtaining the bank control instruction information sets, shown in FIG. 29, will be described more specifically with reference to FIG. 30. FIG. 30 is a flow chart illustrating the operation for obtaining the bank control instruction information shown in FIG. 49A. The flow chart corresponds to the operation of Step ST1302 in FIG. 28.

Step ST1400 is to obtain information on the addresses of memories, in which data sets that are specified to be assigned to different banks by a bank control instruction are stored.

In Step ST1401, the memory address information set obtained in Step ST1400 is registered in the corresponding bank control instruction information set, and connected to the bank control instruction information list.

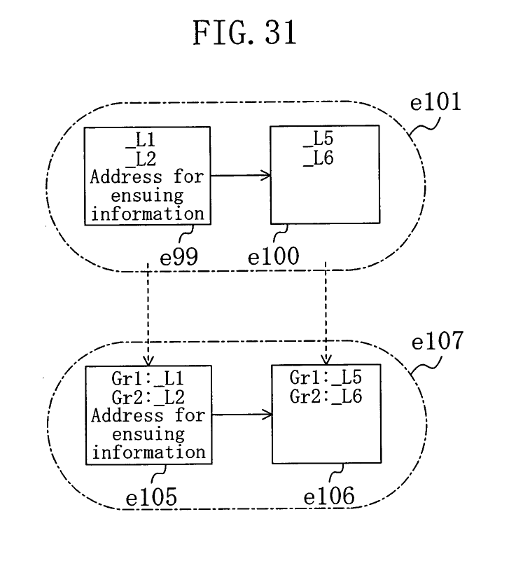

Next, referring to FIG. 31, a bank control method in which data sets to be assigned to different banks are specified by bank control instructions, will be described as a bank control method in the fifth embodiment.

The reference mark e101 indicates a bank control instruction information list. The reference marks e99 and e100 represent bank control instruction information sets included in the bank control instruction information list e101.

The reference marks e105 and e106 indicate bank assignment group information sets for bank control instructions, created from the bank control instruction information sets e99 and e100.

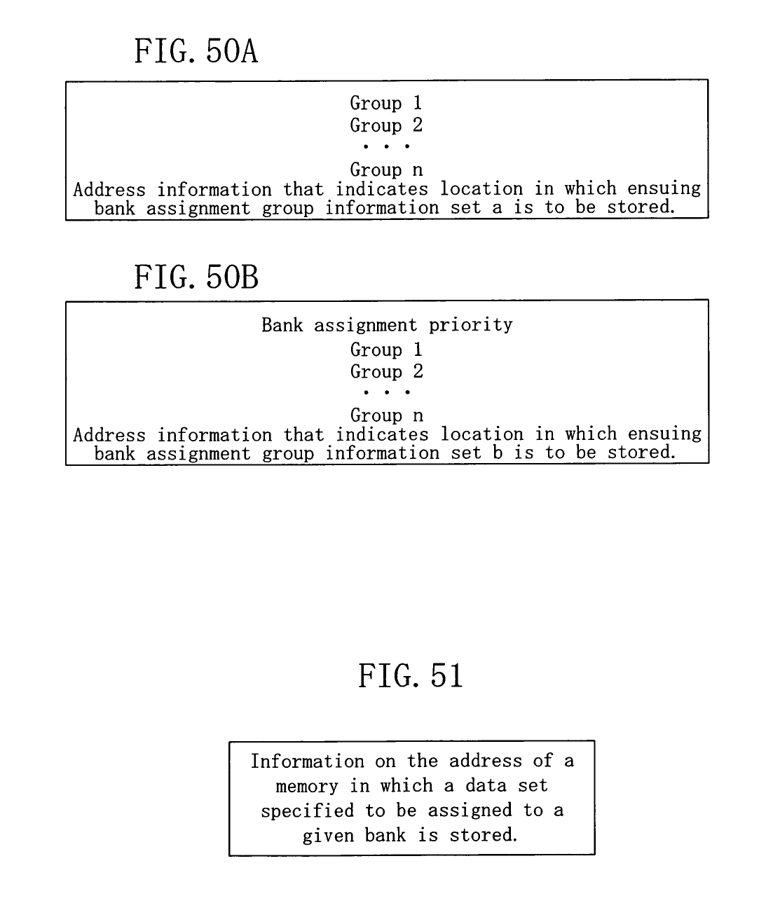

Now, bank assignment group information sets for bank control instructions produced in the fifth embodiment will be described with reference to FIG. 50A. In the fifth embodiment, bank assignment group information for bank control instruction shown in FIG. 50A is generated. Each bank-control-instruction bank assignment group information set shown in FIG. 50A includes: information obtained as result of the grouping of memory addresses performed based on the bank control instruction information in such a manner that the addresses of memories in which data sets to be assigned to the same bank are stored are grouped into the same group, while the addresses of memories in which data sets to be assigned to different banks are stored are grouped into different groups; and address information that indicates where the ensuing bank assignment group information set is to be stored. In this embodiment, the number of groups is equal to the number of banks. By holding the address information that indicates the ensuing-bank-assignmentgroup-information-set storage location, all of the bank-control-instruction bank assignment group information sets are connected in a list structure. The address information that indicates the ensuing-bank-assignment-group-information-set storage location, is registered at the time that the ensuing bank assignment group information set has been created.

Therefore, the bank-control-instruction bank assignment group information set e105 generated from the bank control instruction information set e99 indicates the results of grouping memories in which data L1 and data L2 are stored, into different groups so that memory addresses _L1 and _L2 registered in memory address information in the bank control instruction information set e99 are grouped into Gr1 and Gr2, respectively.

Further, the bank-control-instruction bank assignment group information set e106 generated from the bank control instruction information set elOO indicates the results of grouping memories in which data L5 and data L6 are stored, into different groups so that memory addresses _L5 and _L6 registered in memory address information in the bank control instruction information set e100 are grouped into Gr1 and Gr2, respectively. The bank-control-instruction bank assignment group information set e106 is connected to the bank-control-instruction bank assignment group information set e105.

The above operations produce a bank-control-instruction bank assignment group information list e107, which includes the bank-control-instruction bank assignment group information sets e105 and e106. Assigning of the data sets to banks is performed in sequence beginning with the data sets indicated by the memory addresses registered in the bank-control-instruction bank assignment group information set e105 at the head of the bank assignment group information list e107.

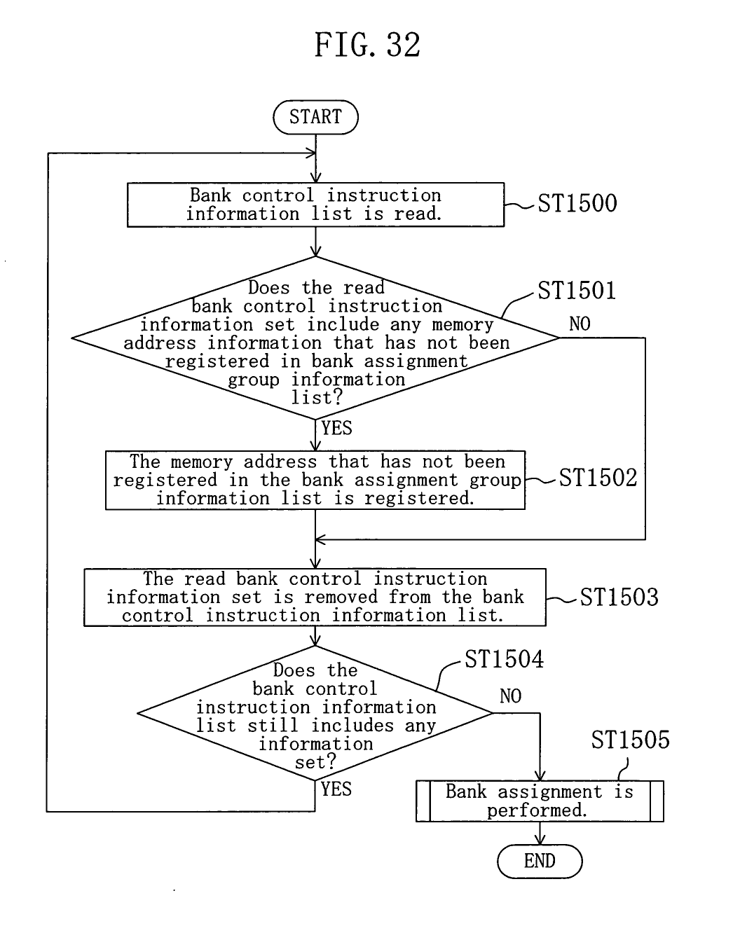

Next, the bank control method performed in accordance with the bank control instructions, shown in FIG. 31, will be described more specifically with reference to FIG. 32. FIG. 32 is a flow chart illustrating the bank control method in which data sets to be assigned to different banks are specified by the bank control instructions. The flow chart corresponds to the operation of Step ST1305 in FIG. 28.

In Step ST1500, the head of the bank control instruction information list is read.

In Step ST1501, it is determined whether the memory addresses indicated by memory address information within the read bank control instruction information set include any memory address that has not been registered in the bank-control-instruction bank assignment group information list.

If it has been determined in Step ST1501 that there is such a memory address that has not been registered in the bank-control-instruction bank assignment group information list, then in Step ST1502 the unregistered memory address is registered in the bank assignment group information list as a group which is different from a group in which the other memory address that the memory address information within the same bank control instruction information set indicates has already been registered.

In Step ST1503, the read bank control instruction information set is removed from the bank control instruction information list.

In Step ST1504, it is determined whether the bank control instruction information list still includes any bank control instruction information set that has not yet been processed.

If it has been determined in Step ST1504 that the bank control instruction information list still includes such a bank control instruction information set that has not yet been processed, the process returns to Step ST1500 to repeat the operations of Steps ST1500 through ST1504.

If it has been determined in Step ST1504 that the bank control instruction information list includes no bank control instruction information set that has not been processed, bank assignment is performed in Step ST1505.

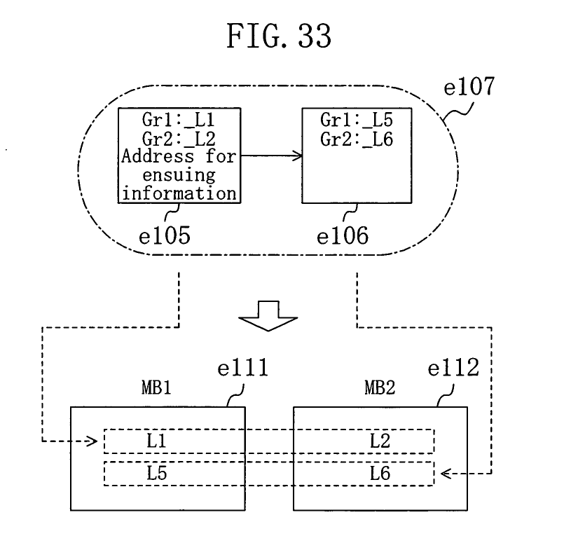

Next, bank assignment operation that corresponds to the operation of Step ST1505 in FIG. 32 will be discussed using an example shown in FIG. 33. FIG. 33 indicates an exemplary bank assignment operation in which data sets to be assigned to different banks are specified by bank control instructions.

The reference mark e107 denotes a bank-control-instruction bank assignment group information list. The reference marks e105 and e106 indicate bank assignment group information sets for bank control instructions included in the bank-control-instruction bank assignment group information list e107.

The reference marks e111 and e112 indicate memory banks in which data sets are stored, and show exemplary results of assigning to the banks the data sets that are specified to be assigned to different banks by bank control instructions. Specifically, the memory banks e111 and e112 show the results of assigning the data sets to the banks in sequence beginning with the data sets stored in the areas indicated by the memory addresses registered in the bank-control-instruction bank assignment group information set e105 at the head of the bank-control-instruction bank assignment group information list e107. In FIG. 33, data L1 and data L5 are assigned to the memory bank MB1, while data L2 and data L6 are assigned to the memory bank MB2. Alternatively, the data L2 and data L6 may be assigned to the memory bank MB1, whereas the data L1 and data L5 may be assigned to the memory bank MB2.

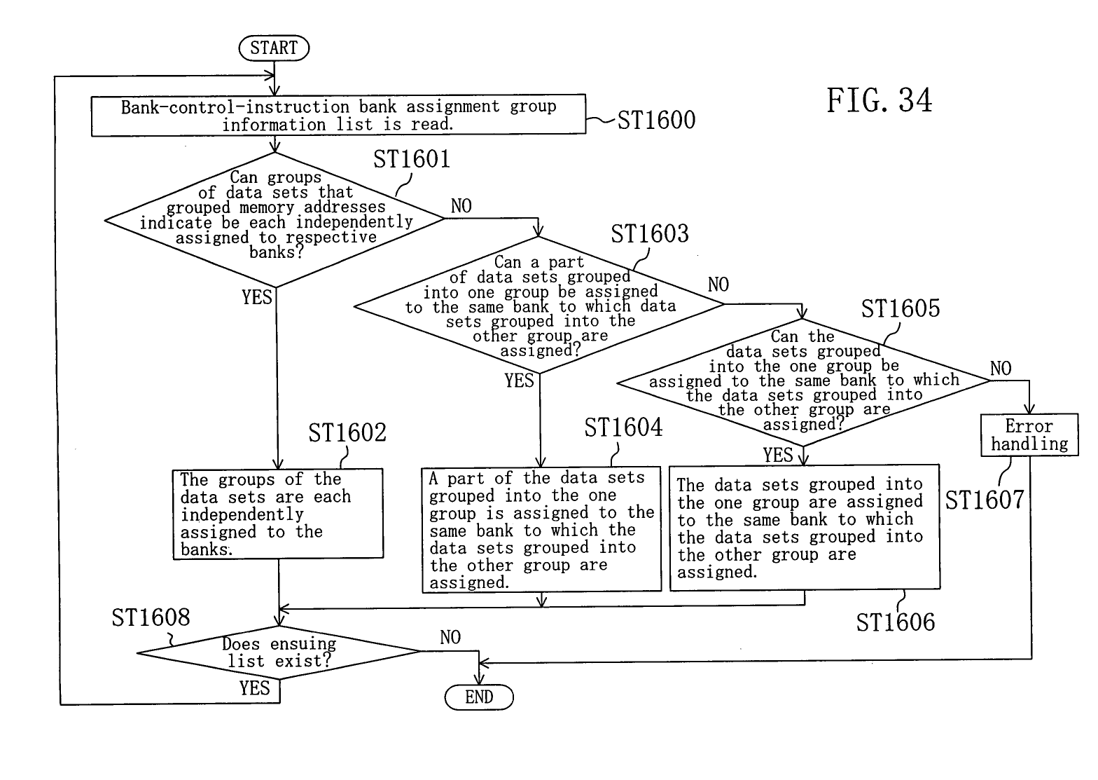

Subsequently, referring to FIG. 34, the bank assignment operation shown in FIG. 33 will be described more specifically. FIG. 34 is a flow chart illustrating the bank assignment operation in which data sets to be assigned to different banks are specified by the bank control instructions. The flow chart corresponds to the operation of Step ST1505 in FIG. 32.

In Step ST1600, the bank-control-instruction bank assignment group information list is read from the head.

In Step ST1601, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment group information sets.

If it has been determined in Step ST1601 that such independent assignment to the banks is possible, then in Step ST1602 the groups of the data sets indicated by the grouped memory addresses are each independently assigned to their respective banks. In each of the read bank assignment group information sets, if the data sets that the grouped memory addresses indicate include a data set that has already been assigned to a bank, the other data set that has not yet been assigned to a bank is assigned to the other bank which is different from the bank of the already assigned data set. If the data sets are assigned in Step ST1602, no memory bank conflict occurs.

If it has not been determined in Step ST1601 that such independent assignment to the banks is possible, then in Step ST1603 a determination is made as to whether it is possible to assign all of the data sets to the banks by assigning a part of the data sets that the memory addresses grouped into the one group indicate, to the same bank to which the data sets that the memory addresses grouped into the other group indicate are assigned.

If it has been determined in Step ST1603 that it is possible to assign all of the data sets to the banks by assigning a part of the data sets that the memory addresses grouped into the one group indicate, to the same bank to which the data sets that the memory addresses grouped into the other group indicate are assigned, then in Step ST1604 a part of the data sets that the memory addresses grouped into the one group indicate is assigned to the same bank to which the data sets that the memory addresses grouped into the other group indicate are assigned. When the data sets are assigned in Step ST1604, memory bank conflict occurs partially.

If it has not been determined in Step ST1603 that it is possible to assign all of the data sets to the banks by assigning a part of the data sets that the memory addresses grouped into the one group indicate, to the same bank to which the data sets that the memory addresses grouped into the other group indicate are assigned, then in Step ST1605 a determination is made as to whether it is possible to assign all of the data sets to the banks by assigning the data sets that the memory addresses grouped into the one group indicate, to the same bank to which the data sets that the memory addresses grouped into the other group indicate are assigned.

If it has been determined in Step ST1605 that it is possible to assign all of the data sets to the banks by assigning the data sets that the memory addresses grouped into the one group indicate, to the same bank to which the data sets that the memory addresses grouped into the other group indicate are assigned, then in Step ST1606 the data sets that the memory addresses grouped into the one group indicate are assigned to the same bank to which the data sets that the memory addresses grouped into the other group indicate are assigned. When the data sets are assigned in Step ST1606, memory bank conflict occurs.

If it has not been determined in Step ST1605 that it is possible to assign all of the data sets to the banks by assigning the data sets that the memory addresses grouped into the one group indicate, to the same bank to which the data sets that the memory addresses grouped into the other group indicate are assigned, then in Step ST1607 error handling is performed.

In Step ST1608, it is determined whether there exists an ensuing information set in the bank-control-instruction bank assignment group information list.

If it has been determined in Step ST1608 that the ensuing information exits, the process returns to Step ST1600 to repeat the operations of Step ST1600 through Step ST1608.

As described above, in the fifth embodiment, data sets specified by the user are allowed to be assigned preferentially to banks without causing memory bank conflict.

(Sixth embodiment)

In a sixth embodiment, a bank assignment method in which priority levels for bank control are set by bank control instructions, will be described. In the sixth embodiment, the method shown in FIG. 28 is used. Now, referring to FIG. 49B, bank control instruction information obtained in the sixth embodiment will be described. A bank control instruction information set shown in FIG. 49B is produced each time a bank control instruction is read. The bank control instruction information set includes: information on the addresses of memories in which data sets designated by the bank control instruction are stored; information on bank control priority; and address information that indicates a location in which an ensuing bank control instruction information set is to be stored. By holding the address information that indicates the ensuing-bank-control-instruction-information-set storage location, all of the bank control instruction information sets are connected in a list structure. The address information that indicates the ensuing-bank-control-instruction-information-set storage location is registered at the time that the ensuing bank control instruction information set has been created.

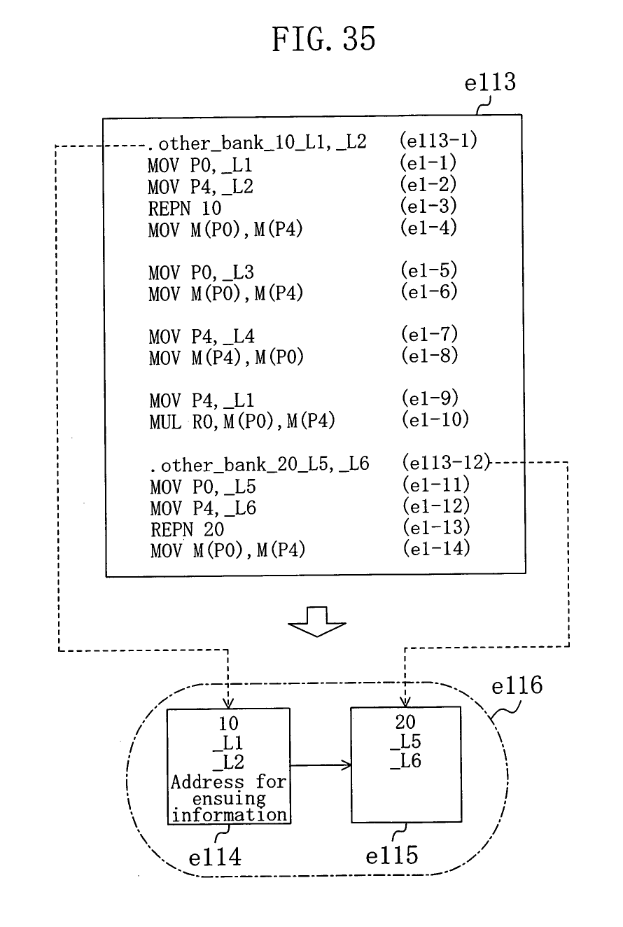

Next, operation for obtaining the bank control instruction information set shown in FIG. 49B will be discussed with reference to FIG. 35.

The reference mark e113 indicates an example of an input program in which memory reference instructions and bank control instructions are written. The input program e113 is one obtained by changing the respective bank control instructions e93-1 and e93-12 in the input program e93 to bank control instructions e113-1 and e113-12 having priority levels.

The reference mark e114 indicates a bank control instruction information set obtained in accordance with the bank control instruction e113-1. The bank control instruction e113-1 specifies that data L1 and data L2 are assigned to different banks at a priority level of 10. Thus, in memory address information in the bank control instruction information set e114, the address _L1 of a memory in which the data L1 is stored and the address _L2 of a memory in which the data L2 is stored are registered, and the level “10” is registered as a bank assignment priority level.

The reference mark e15 indicates a bank control instruction information set obtained according to the bank control instruction e113-12. The bank control instruction e113-12 specifies that data L5 and the data L6 are assigned to different banks at a priority level of 20. Thus, in memory address information in the bank control instruction information set e115, the address _L5 of a memory in which the data L5 is stored and the address _L6 of a memory in which the data L6 is stored are registered, and the level “20” is registered as a bank assignment priority level. The bank control instruction information set e115 is connected to the bank control instruction information set e114.

The above operations produce a bank control instruction information list e116 that includes the bank control instruction information sets e114 and e115.

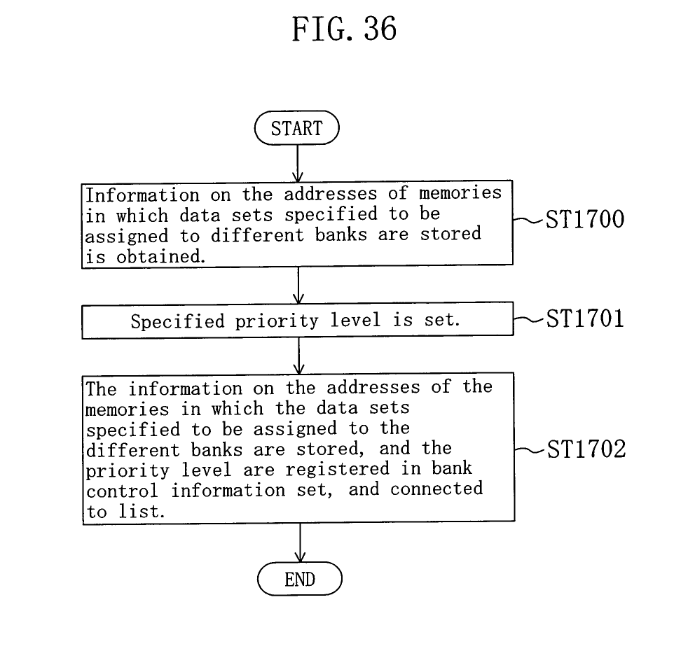

Subsequently, the operation for obtaining the bank control instruction information sets, shown in FIG. 35, will be described more specifically with reference to FIG. 36. FIG. 36 is a flow chart illustrating the operation for obtaining the bank control instruction information shown in FIG. 49B. The flow chart corresponds to the operation of Step ST1302 in FIG. 28.

Step ST1700 is to obtain information on the addresses of memories in which data sets specified to be assigned to different banks are stored.

In Step ST1701, a specified priority level is set as a bank control priority level.

In Step ST1702, the memory address information obtained in Step ST1700 and the bank control priority level obtained in Step ST1701 are registered in the corresponding bank control instruction information set, and connected to the bank control instruction information list.

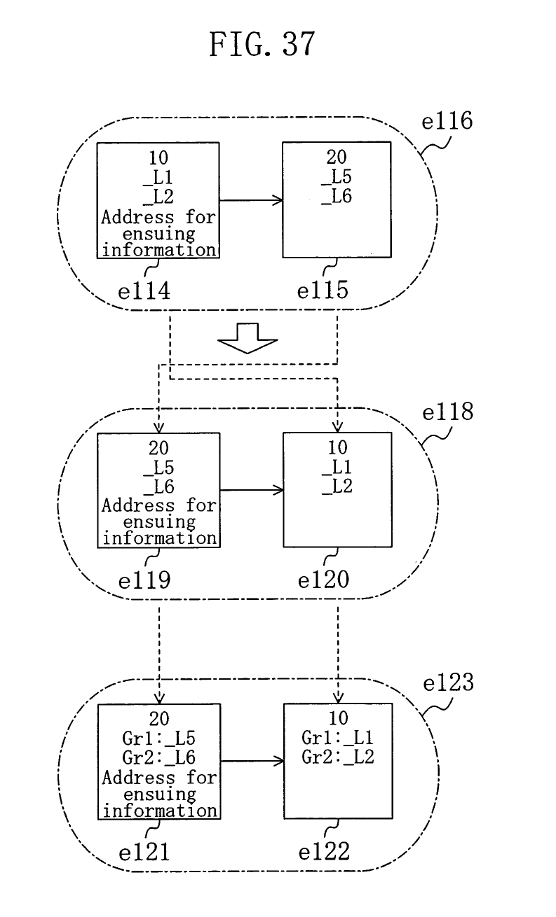

Next, referring to FIG. 37, a bank control method in which priority levels for bank control are set by bank control instructions, will be described as a bank control method in the sixth embodiment.

The reference mark e116 indicates a bank control instruction information list. The reference mark e118 indicates a list obtained by rearranging the bank control instruction information list e116 in order of decreasing priority levels. The reference marks e119 and e120 represent bank control instruction information sets included in the bank control instruction information list e118. The reference marks e121 and e122 indicate bank assignment group information sets for bank control instructions, created from the bank control instruction information sets e119 and e120.

Now, bank assignment group information sets for bank control instructions, produced in the sixth embodiment, will be described with reference to FIG. 50B. In the sixth embodiment, bank-control-instruction bank assignment group information shown in FIG. 50B is generated.

Each bank-control-instruction bank assignment group information set shown in FIG. 50B includes: information obtained as result of the grouping of memory addresses performed based on the bank control instruction information in such a manner that the addresses of memories in which data sets to be assigned to the same bank are stored are grouped into the same group, while the addresses of memories in which data sets to be assigned to different banks are stored are grouped into different groups; information on priority for bank assignment; and address information that indicates where the ensuing bank assignment group information set is to be stored. In this embodiment, the number of groups is equal to the number of banks. By holding the address information that indicates the ensuing-bank-assignment-group-information-set storage location, all of the bankcontrol-instruction bank assignment group information sets are connected in a list structure. The address information that indicates the ensuing-bank-assignment-group-information-set storage location, is registered at the time when the ensuing bank assignment group information set has been created.

Therefore, the bank-control-instruction bank assignment group information set e121, generated from the bank control instruction information set e119, indicates the results of grouping memories in which data L5 and data L6 are stored, into different groups so that memory addresses _L5 and _L6 registered in memory address information in the bank control instruction information set e119 are grouped into Gr1 and Gr2, respectively. Further, a priority level registered in the bank control instruction information set e119 is registered as a bank assignment priority level.

Next, the bank-control-instruction bank assignment group information set el22, generated from the bank control instruction information set e120, indicates the results of grouping memories in which data L1 and data L2 are stored, into different groups so that memory addresses _L1 and _L2 registered in memory address information in the bank control instruction information set e120 are grouped into Gr1 and Gr2, respectively. Further, a priority level registered in the bank control instruction information set el20 is registered as a bank assignment priority level. The bank-control-instruction bank assignment group information set e122 is connected to the bank-control-instruction bank assignment group information set e121.

The above operations produce a bank-control-instruction bank assignment group information list e123, which includes the bank-control-instruction bank assignment group information sets e121 and e122. Assigning of the data sets to banks is performed in sequence beginning with the data sets indicated by the memory addresses registered in the bank-control-instruction bank assignment group information set e121 at the head of the bank assignment group information list e123.

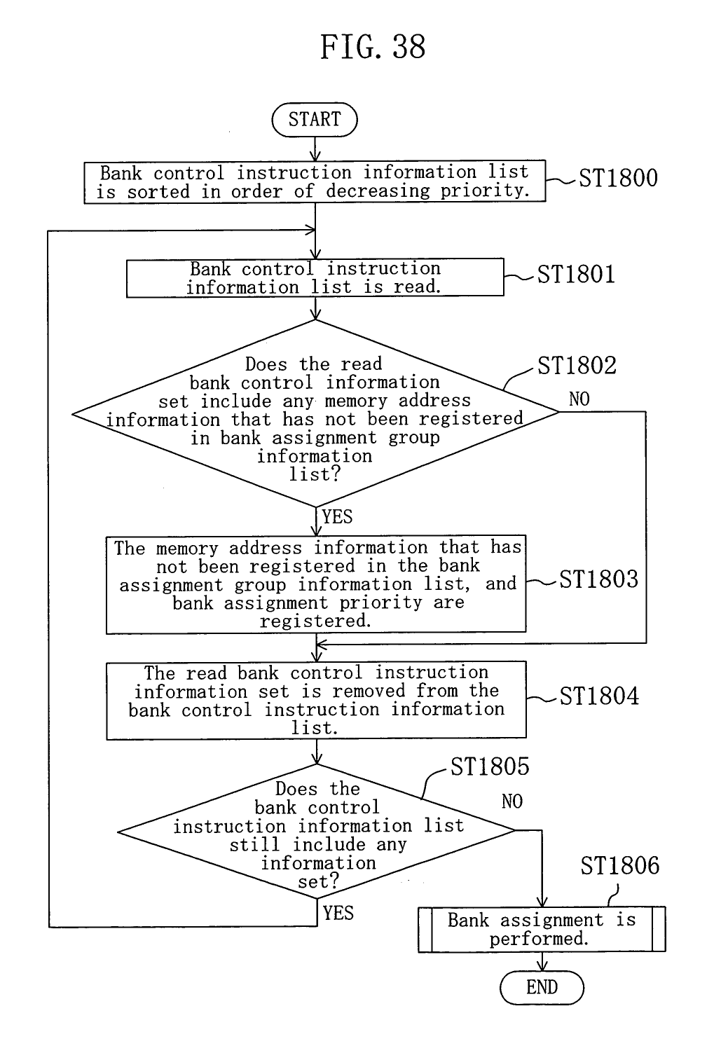

Next, the bank control method in accordance with the bank control instructions, shown in FIG. 37, will be described more specifically with reference to FIG. 38. FIG. 38 is a flow chart illustrating the bank control method in which priority levels for bank control are established by the bank control instructions. The flow chart corresponds to the operation of Step ST1305 in FIG. 28.

In Step ST1800, the bank control instruction information list is sorted in order of decreasing priority.

In Step ST1801, the head of the bank control instruction information list is read.

In Step ST1802, it is determined whether the memory addresses indicated by memory address information in the read bank control instruction information set include any memory address that has not been registered in the bank-control-instruction bank assignment group information list.

If it has been determined in Step ST1802 that there is such a memory address that has not yet been registered in the bank-control-instruction bank assignment group information list, then in Step ST1803 the unregistered memory address is registered in the bank assignment group information list as a group which is different from a group in which the other memory address that the memory address information in the same bank control instruction information set indicates has already been registered.

In Step ST1804, the read bank control instruction information set is removed from the bank control instruction information list.

In Step ST1805, it is determined whether the bank control instruction information list still includes any bank control instruction information set that has not yet been processed.

If it has been determined in Step ST1805 that the bank control instruction information list still includes such a bank control instruction information set that has not yet been processed, the process returns to Step ST1801 to repeat the operations of Steps ST1801 through ST1805.

If it has been determined in Step ST1805 that the bank control instruction information list includes no bank control instruction information set that has not been processed, bank assignment is performed in Step ST1806.

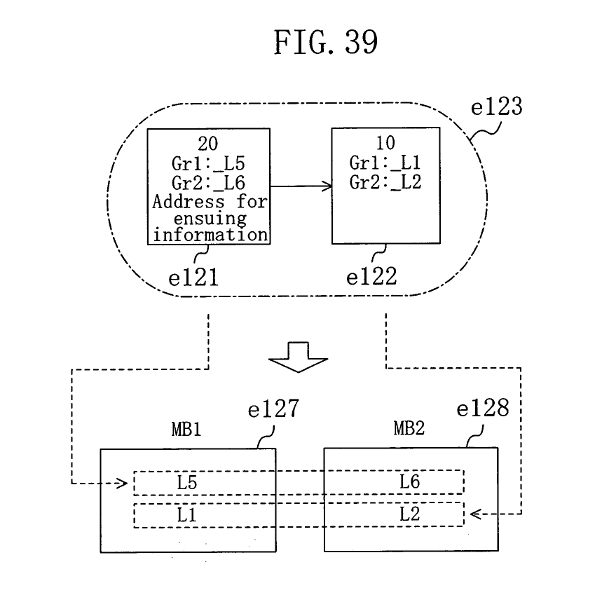

Next, bank assignment operation that corresponds to the operation of Step ST1806 in FIG. 38 will be discussed using an example shown in FIG. 39. FIG. 39 illustrates an exemplary bank assignment operation in which priority levels for bank control are established by bank control instructions.

The reference mark e123 denotes a bank-control-instruction bank assignment group information list. The reference marks e121 and e122 indicate bank-control-instruction bank assignment group information sets included in the bank-control-instruction bank assignment group information list e123.

The reference marks e127 and e128 indicate memory banks in which data sets are stored, and show exemplary results of assigning to the banks the data sets that are specified to be assigned to different banks by bank control instructions. Specifically, the memory banks e127 and e128 show the results of assigning the data sets to the banks in sequence beginning with the data sets stored in the areas indicated by the memory addresses registered in the bank-control-instruction bank assignment group information set e121 at the head of the bank-control-instruction bank assignment group information list. In FIG. 39, data L5 and data L1 are assigned to the memory bank MB1, while data L6 and data L2 are assigned to the memory bank MB2. Alternatively, the data L6 and data L2 may be assigned to the memory bank MB1 whereas the data L5 and data L1 may be assigned to the memory bank MB2.

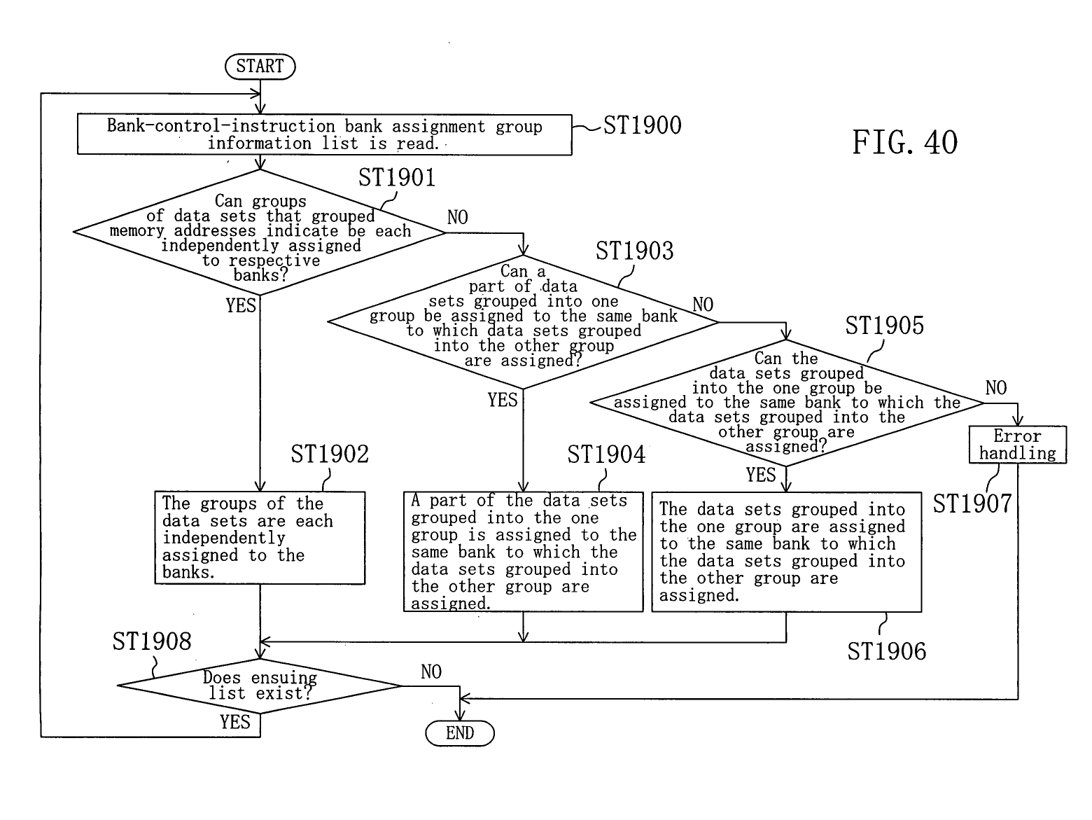

Subsequently, referring to FIG. 40, the bank assignment operation shown in FIG. 39 will be described more specifically. FIG. 40 is a flow chart illustrating the bank assignment operation in which priority levels for bank control are established by the bank control instructions. The flow chart corresponds to the operation of Step ST1806 in FIG. 38.

In Step ST1900, the bank-control-instruction bank assignment group information list is read from the head.

In Step ST1901, a determination is made as to whether a group of data sets that memory addresses grouped into one of the groups indicate can be assigned independently to a bank without being assigned to the other bank, i.e., the bank to which a group of data sets that memory addresses grouped into the other group indicate is assigned, wherein the memory addresses are grouped in the read bank assignment group information sets.

If it has been determined in Step ST1901 that such independent assignment to the banks is possible, then in Step ST1902 the groups of the data sets indicated by the grouped memory addresses are each independently assigned to their respective banks. In each of the read bank assignment group information sets, if the data sets that the grouped memory addresses indicate include a data set that has already been assigned to a bank, the other data set that has not yet been assigned to a bank is assigned to the other bank which is different from the bank of the already assigned data set. If the data sets are assigned in Step ST1902, no memory bank conflict occurs.

If it has not been determined in Step ST1901 that such independent assignment to the banks is possible, then in Step ST1903 a determination is made as to whether it is possible to assign all of the data sets to the banks by assigning a part of the data sets that the memory addresses grouped into the one group indicate, to the same bank to which the data sets that the memory addresses grouped into the other group indicate are assigned.

If it has been determined in Step ST1903 that it is possible to assign all of the data sets to the banks by assigning a part of the data sets that the memory addresses grouped into the one group indicate, to the same bank to which the data sets that the memory addresses grouped into the other group indicate are assigned, then in Step ST1904 a part of the data sets that the memory addresses grouped into the one group indicate is assigned to the same bank to which the data sets that the memory addresses grouped into the other group indicate are assigned. If the data sets are assigned in Step ST1904, memory bank conflict occurs partially.

If it has not been determined in Step ST1903 that it is possible to assign all of the data sets to the banks by assigning a part of the data sets that the memory addresses grouped into the one group indicate, to the same bank to which the data sets that the memory addresses grouped into the other group indicate are assigned, then in Step ST1905 a determination is made as to whether it is possible to assign all of the data sets to the banks by assigning the data sets that the memory addresses grouped into the one group indicate, to the same bank to which the data sets that the memory addresses grouped into the other group indicate are assigned.

If it has been determined in Step ST1905 that it is possible to assign all of the data sets to the banks by assigning the data sets that the memory addresses grouped into the one group indicate, to the same bank to which the data sets that the memory addresses grouped into the other group indicate are assigned, then in Step ST1906 the data sets that the memory addresses grouped into the one group indicate are assigned to the same bank to which the data sets that the memory addresses grouped into the other group indicate are assigned. When the data sets are assigned in Step ST1906, memory bank conflict occurs.

If it has not been determined in Step ST1905 that it is possible to assign all of the data sets to the banks by assigning the data sets that the memory addresses grouped into the one group indicate, to the same bank to which the data sets that the memory addresses grouped into the other group indicate are assigned, then in Step ST1907 error handling is performed.

In Step ST1908, it is determined whether there exists an ensuing information set in the bank-control-instruction bank assignment group information list.

If it has been determined in Step ST1908 that the ensuing information exits, the process returns to Step ST1900 to repeat the operations of Step ST1900 through Step ST1908.

As described above, in the sixth embodiment, priority levels are established among the data sets that are specified by the user, which allows particularly important data sets to be assigned to banks without causing any memory bank conflict.

(Seventh embodiment)

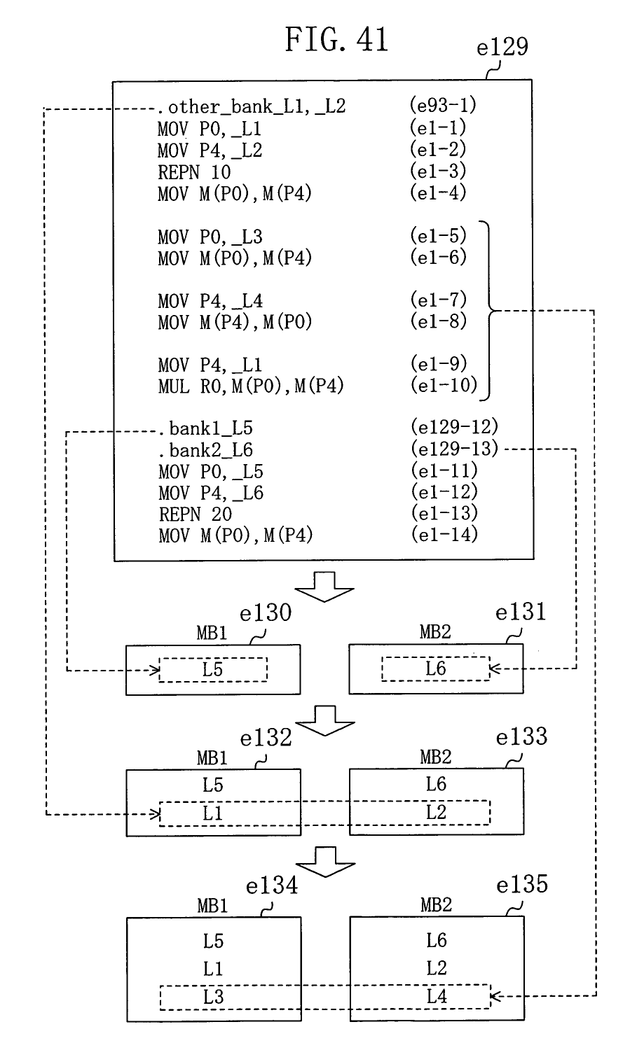

In a seventh embodiment, a bank assignment method using bank-specifying instructions will be described. Specifically, referring to FIG. 41, a method in which the functions described in the first through fourth embodiments are supported by user-described bank-specifying instructions, will be described. FIG. 41 indicates a simplest example of bank assignment, in which bank-specifying instructions specify to which banks given data sets should be assigned, wherein the processor includes two banks.

The reference mark e129 denotes an example of an input file in which memory reference instructions, a bank control instruction and bank-specifying instructions are written. The input file el29 is one obtained by adding bank-specifying instructions e129-12 and e129-13 to the input file e93.

The bank-specifying instruction e129-12 is an instruction that specifies that data L5 is assigned to a memory bank MB1. The designated data L5 is assigned preferentially to the memory bank MB1.

The bank-specifying instruction e129-13 is an instruction that specifies that data L6 is assigned to a memory bank MB2. The designated data L6 is assigned preferentially to the memory bank MB2.

The reference marks e130 and e131 indicate examples of the results of assigning the data L5 and data L6, designated by the bank-specifying instructions, preferentially to the respective banks.

After the data sets designated by the bank-specifying instructions have been assigned to the specified banks, data L1 and data L2 that are specified to be assigned to different banks by a bank control instruction are assigned to the banks. The reference marks e132 and e133 indicate examples of the memory banks after the data sets designated by the bank control instruction have been assigned to the banks.

After the data sets designated by the bank control instruction have been assigned to the banks, among the data sets referred to in the input file e129, data L3 and data L4 that are not designated either by the bank-specifying instructions nor the bank control instruction, are assigned to the banks. The reference marks e134 and e135 indicate examples of the memory banks after the data sets that are not specified either by the bankspecifying instructions nor the bank control instruction have been assigned to the banks.

Assigning in the above manner to the banks all of the data sets L1 through L6 that are referred to in the input file e129 results in the memory banks e34 and e135.

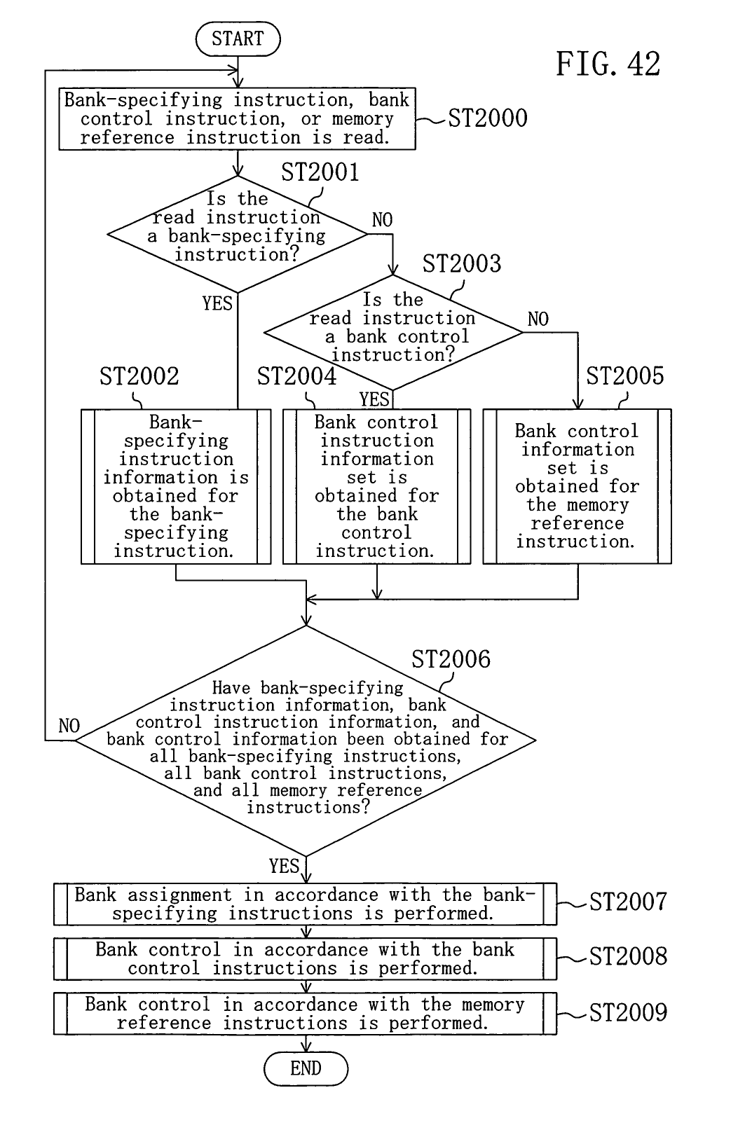

Next, an information processing method for performing bank assignment in which bank-specifying instructions are used, as shown in FIG. 41, will be described. FIG. 42 is a flow chart illustrating process steps in bank control in which bank-specifying instructions specify to which banks given data sets should be assigned.

In Step ST2000, a bank-specifying instruction, a bank control instruction, or a memory reference instruction that is performed by the arithmetic processing unit 12 is read.

In Step ST2001, it is determined whether the read instruction is a bank-specifying instruction.

If it has been determined in Step ST2001 that the read instruction is a bank-specifying instruction, then in Step ST2002 necessary information for bank assignment performed according to the bank-specifying instruction (which will be hereinafter referred to as “bank-specifying instruction information”) is obtained for the bank-specifying instruction.

If it has not been determined in Step ST2001 that the read instruction is a bank-specifying instruction, then in Step ST2003 it is determined whether the read instruction is a bank control instruction.

If it has been determined in Step ST2003 that the read instruction is a bank control instruction, then in Step ST2004 a bank control instruction information set is obtained for the bank control instruction. In Step ST2004, the method shown in FIG. 29 or 35 is used.

If it has not been determined in Step ST2003 that the read instruction is a bank control instruction, then in Step ST2005 a bank control information set is obtained for the read instruction. In Step ST2005, the method shown in FIG. 7 or 13 is used.

In Step ST2006, it is determined whether bank-specifying instruction information sets, bank control instruction information sets, and bank control information sets have been obtained for all the bank-specifying instructions, all the bank control instructions, and all the memory reference instructions.

If it has not been determined in Step ST2006 that all of the information sets have been obtained, the process returns to Step ST2000 to repeat the operations of Step ST2000 through Step ST2006.

If it has been determined in Step ST2006 that all of the information sets have been obtained, then in Step ST2007 the data sets designated by the bank-specifying instructions are assigned to the banks.

In Step ST2008, the data sets designated by the bank control instructions are assigned to the banks. In Step ST2008, the method shown in FIG. 32 or 38 is used in accordance with the bank control instruction information obtained in Step ST2004.

In Step ST2009, bank control is performed for, among the data sets referred to by the memory reference instructions, data sets that are not designated by the bank-specifying instructions nor the bank control instructions. In step ST2009, one of the methods shown in FIGS. 10, 16, 20, and 24 is used in accordance with the bank control information obtained in Step ST2005.

Now, referring to FIG. 51, the bank-specifying instruction information obtained in the seventh embodiment will be described. Each time a bank-specifying instruction is read, specified data is registered in the bank-specifying instruction information set shown in FIG. 51. The bank-specifying instruction information set retains information on data sets specified to be assigned to given banks.

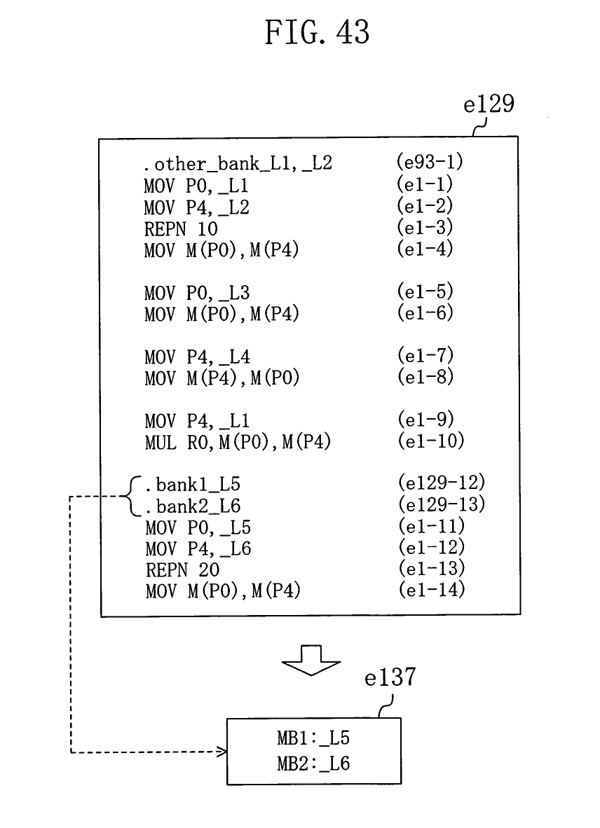

Next, operation for obtaining the bank-specifying instruction information set shown in FIG. 51 will be discussed referring to an example shown FIG. 43.

The reference mark e129 indicates an example of an input program in which memory reference instructions, a bank control instruction, and bank-specifying instructions are written. The reference mark e137 indicates a bank-specifying instruction information set obtained in accordance with bank-specifying instructions e129-12 and e129-13. The bank-specifying instruction e129-12 specifies that data L5 is assigned to a memory bank MB1, whereas the bank-specifying instruction e129-13 specifies that data L6 is assigned to a memory bank MB2. Thus, in memory address information in the bank-specifying instruction information set e137, the address _L5 of a memory in which the data L5 is stored and the address _L6 of a memory in which the data L6 is stored, are registered as memory address information on data assigned to the memory bank MB1 and as memory address information on data assigned to the memory bank MB2, respectively.

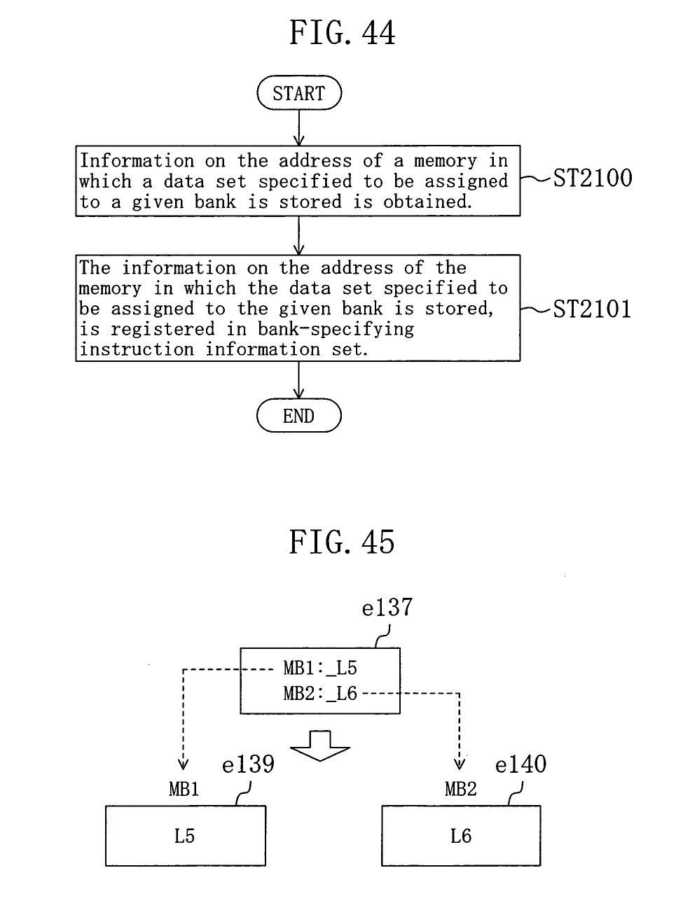

Subsequently, the operation for obtaining the bank-specifying instruction information set, shown in FIG. 43, will be described more specifically with reference to FIG. 44. FIG. 44 is a flow chart illustrating the operation for obtaining the bank-specifying instruction information set shown in FIG. 51. The flow chart corresponds to the operation of Step ST2002 in FIG. 42.

Step ST2100 is to obtain information on the address of a memory in which a data set specified to be assigned to a given bank is stored.

In Step ST2101, the memory address information obtained in Step ST2100 is registered in the bank-specifying instruction information set.

Next, referring to FIG. 45, a bank assignment operation in which bank-specifying instructions specify to which banks given data sets should be assigned, will be described as a bank control method in the seventh embodiment.

The reference mark el37 indicates a bank-specifying instruction information set. The reference marks el39 and el40 indicate memory banks in which data sets are stored, and show the results of assigning to the banks the data sets that are specified to be assigned to given banks by bank-specifying instructions.

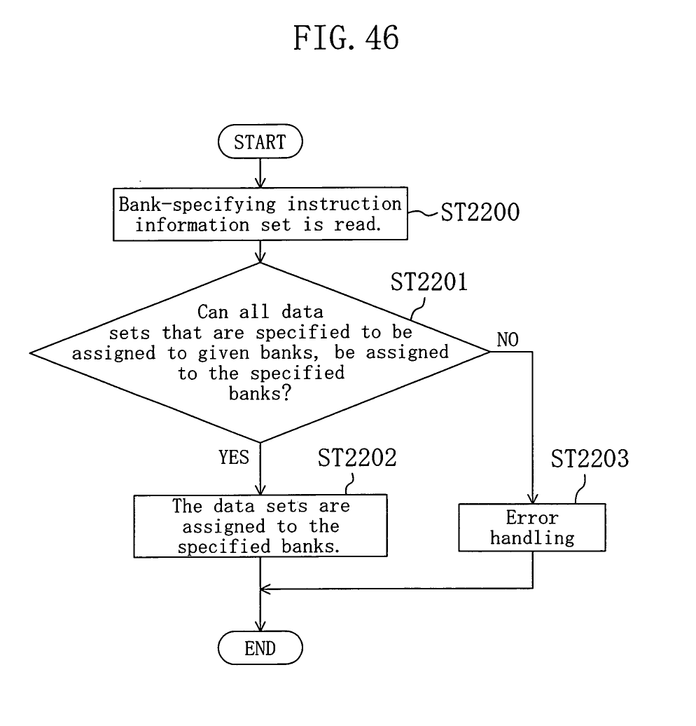

Next, referring to FIG. 46, the bank assignment operation shown in FIG. 45 will be described more specifically. FIG. 46 is a flow chart illustrating the bank assignment method in which bank-specifying instructions specify to which banks given data sets should be assigned. The flow chart corresponds to the operation of Step ST2007 in FIG. 42.

In Step ST2200, a bank-specifying instruction information set is read.

In Step ST2201, a determination is made as to whether it is possible to assign to specified banks the data sets indicated by all of the memory addresses registered in memory address information in the bank-specifying instruction information set.

If it has been determined in Step ST2201 that the assignment of all the data sets is possible, then in Step ST2202 the data sets indicated by all of the memory addresses registered in the memory address information in the bank-specifying instruction information set, are assigned to their respective specified banks.

If it has not been determined in Step ST2201 that the assignment of all the data sets is possible, then in Step ST2203 error handling is performed.

As described above, in the seventh embodiment, data sets that the user specifies to assign to given banks are allowed to be assigned preferentially to the specified banks.

As described above, information on data sets that are referred to simultaneously by memory reference instructions is obtained, and those data sets referred to simultaneously are assigned to different banks, which allows bank assignment to be performed automatically without causing memory bank conflict. Further, bank control instructions and bank-specifying instructions enable bank assignment to be performed just as intended by the user.

What is claimed is:

1. An information processing method comprising the steps of:
(a) obtaining, among arithmetic instructions, information on data sets referred to by memory reference, and
(b) assigning to different banks a plurality of data sets simultaneously referred to by memory reference performed in accordance with an arithmetic instruction.

2. The method of claim 1, further comprising the step of
(c) establishing bank assignment priority,
wherein in the step (b), the assignment to the banks is performed in sequence beginning with data sets that are high in the priority established in the step (c).

3. The method of claim 2, wherein in the step (c), the bank assignment priority is established according to a loop count that indicates the number of times the arithmetic instruction is executed repeatedly.

4. The method of claim 2, wherein in the step (c), the bank assignment priority is established according to data-use frequency.

5. The method of claim 2, further comprising the step of:
(d) searching for data sets referred to simultaneously with the data sets that are high in the priority established in the step (c),
wherein in the step (b), the data sets searched for in the step (d) are assigned preferentially to the banks.

6. An information processing method comprising the steps of:
(a) reading an instruction that specifies data sets to be assigned to different banks, and
(b) assigning to the different banks the data sets that are specified to be assigned to the different banks.

7. The method of claim 6, wherein in the step (b), the data sets that are specified to be assigned to the different banks are assigned preferentially to the banks.

8. The method of claim 7, further comprising the step of
(c) establishing bank assignment priority among the data sets that are specified to be assigned to the different banks,
wherein in the step (b), the assignment to the banks is performed in sequence beginning with data sets that are high in the bank assignment priority.

9. An information processing method comprising the steps of:
(a) reading an instruction that specifies to which bank a data set is assigned, and
(b) assigning the data set to the specified bank.

10. The method of claim 9, wherein in the step (b), the data set is assigned preferentially to the specified bank.

11. An information processor, wherein information on a plurality of data sets simultaneously referred to by memory reference performed in accordance with an arithmetic instruction is obtained, and the data sets are assigned to different banks.

12. The processor of claim 11, wherein the assignment to the banks is performed in sequence beginning with data sets that are high in bank assignment priority.

13. The processor of claim 12, wherein a loop count that indicates the number of times the arithmetic instruction is executed repeatedly is set as the bank assignment priority.

14. The processor of claim 12, wherein data-use frequency is set as the bank assignment priority.

15. The processor of claim 12, wherein data sets that are referred to by the memory reference simultaneously with the high-bank-assignment-priority data sets are also assigned preferentially to the banks.

16. An information processor, wherein data sets to be assigned to different banks are specifiable.

17. The processor of claim 16, wherein the data sets that are specified to be assigned to the different banks are assigned preferentially to the banks.

18. The processor of claim 17, wherein bank assignment priority is established among the data sets that are specified to be assigned to the different banks, and the assignment to the banks is performed in sequence beginning with data sets that are high in the bank assignment priority.

19. An information processor, wherein a bank to which a data set is assigned is specifiable.

20. The processor of claim 19, wherein the data set is assigned preferentially to the specified bank.
